(19) United States
(12) Patent Application Publication
(10) Pub. No.: US 2025/0171278 A1
(43) Pub. Date: May 29, 2025

(54) ROPE INSPECTION DEVICE AND WORK MACHINE EQUIPPED WITH SAME

(71) Applicant: KOBELCO CONSTRUCTION MACHINERY CO., LTD., Hiroshima-shi (JP)

(72) Inventors: Teppei MAEDO, Hyogo (JP); Hiroki NAKAYAMA, Hyogo (JP); Kazufumi KUDARA, Hyogo (JP); Youhei OGAWA, Hyogo (JP)

(73) Assignee: KOBELCO CONSTRUCTION MACHINERY CO., LTD., Hiroshima-shi (JP)

(21) Appl. No.: 18/842,098

(22) PCT Filed: Jan. 26, 2023
(86) PCT No.: PCT/JP2023/002497

§ 371 Date: Aug. 28, 2024

(30) Foreign Application Priority Data
Mar. 4, 2022 (JP) 2022-033683
Sep. 1, 2022 (JP) 2022-139489

(51) Int. Cl. B66C 23/88

(52) U.S. Cl. CPC B66C 23/88

(57) ABSTRACT

A rope inspection device is capable of accurately detecting deterioration of a rope used in a work machine. The rope inspection device is attached to a crane having a machine body that includes a backstop, a boom capable of rising/lowering relative to the machine body, a winch, and a rope that is led out from the winch. The rope inspection device includes a rope inspection unit capable of inspecting the deterioration state of the rope, and a support unit attached to the machine body, the support unit supporting the rope inspection unit so that the rope inspection unit is able to follow the movement of the rope.

### TECHNICAL FIELD

The present invention relates to a rope inspection device and a work machine including the same.

### BACKGROUND ART

A crane that can hoist a load to be suspended is conventionally known as a work machine. The crane has a machine body, a rising/lowering body capable of rising/lowering relative to the machine body, a suspended load rope suspended from a tip end of the rising/lowering body and connected to a load to be suspended, and a suspended load winch for winding and unwinding the suspended load rope. Further, the crane further includes a rising/lowering rope and a rising/lowering winch. The rising/lowering rope is connected to a tip end of the rising/lowering body via a guy link or the like, and when the rising/lowering winch winds and unwinds the rising/lowering rope, the rising/lowering body rises/lowers relative to the machine body. In such a crane, the rope may be deteriorated or damaged with long-term work.

Patent Literature 1 discloses a technique in which the rising/lowering rope is coated with paint, and the color and peeling of the paint are photographed by a camera fixed to the top of a gantry to determine the life of the rope.

### CITATION LIST

### Patent Literature

Patent Literature 1: JP H7-117989 A

In the technique described in Patent Literature 1, since the camera as a rope inspection device is fixed to the top of the gantry, and a distance between the camera and the rope fluctuates according to the operation of the crane, particularly rising/lowering of the boom, there is a problem that it is difficult to accurately detect deterioration of the rope.

### SUMMARY OF INVENTION

The present invention has been made in view of the above problems, and an object of the present invention is to provide a rope inspection device capable of accurately detecting deterioration of a rope used in a work machine, and a work machine including the rope inspection device.

Provided by the present invention is a rope inspection device attached to a work machine having a machine body, a rising/lowering body capable of rising/lowering relative to the machine body, a winch, and a rope that is led out from the winch. The rope inspection device includes a rope inspection unit capable of inspecting a deterioration state of the rope, and a support unit attached to a predetermined attachment target portion of the work machine, the support unit supporting the rope inspection unit so that the rope inspection unit is able to follow movement of the rope.

The present invention provides a work machine. The work machine includes a machine body, a rising/lowering body capable of rising/lowering relative to the machine body, a winch, a rope that is led out from the winch, and the rope inspection device according to any one of the above.

### BRIEF DESCRIPTION OF DRAWINGS

FIG. 1 is a side view of a crane according to a first embodiment of the present invention.

FIG. 2 is a front view of a rope inspection device of the crane according to the first embodiment of the present invention.

FIG. 3 is a side view of the rope inspection device of the crane according to the first embodiment of the present invention.

FIG. 4 is a side cross-sectional view of the rope inspection device of the crane according to the first embodiment of the present invention.

FIG. 5 is a plan view of the rope inspection device of the crane according to the first embodiment of the present invention.

FIG. 6 is a schematic side view illustrating a state of a rope extending from a winch.

FIG. 7 is a side view comparing two states of the rope inspection device of the crane according to the first embodiment of the present invention.

FIG. 8 is a front view of a rope inspection device of a crane according to a second embodiment of the present invention.

FIG. 9 is a front view of the rope inspection device of the crane according to the second embodiment of the present invention.

FIG. 10 is a front view of a rope inspection device of a crane according to a third embodiment of the present invention.

FIG. 11 is a front view of a rope inspection device of a crane according to a fourth embodiment of the present invention.

FIG. 12 is a side view of the rope inspection device of the crane according to the fourth embodiment of the present invention.

FIG. 13 is a plan view of the rope inspection device of the crane according to the fourth embodiment of the present invention.

FIG. 14 is a side view of a rope inspection device of a crane according to a fifth embodiment of the present invention.

FIG. 15 is a plan view of the rope inspection device of the crane according to the fifth embodiment of the present invention.

FIG. 16 is a cross-sectional view of a clamp part of the rope inspection device of the crane according to the fifth embodiment of the present invention.

FIG. 17 is a cross-sectional view of the clamp part of the rope inspection device of the crane according to the fifth embodiment of the present invention.

FIG. 18 is a side view of a rope inspection device of a crane according to a sixth embodiment of the present invention.

FIG. 19 is a plan view of the rope inspection device of the crane according to the sixth embodiment of the present invention.

FIG. 20 is a front view of a rope inspection device of a crane according to a seventh embodiment of the present invention.

FIG. 21 is a side view of the rope inspection device of the crane according to the seventh embodiment of the present invention.

FIG. 22 is a perspective view illustrating a drum cover to which the rope inspection device of the crane according to the seventh embodiment of the present invention is attached.

FIG. 23 is a perspective view of a rope inspection device of a crane according to an eighth embodiment of the present invention.

FIG. 24 is a side view of the rope inspection device of the crane according to the eighth embodiment of the present invention.

FIG. 25 is a plan view of the rope inspection device of the crane according to the eighth embodiment of the present invention.

FIG. 26 is a plan view of a rope inspection device of a crane according to a ninth embodiment of the present invention.

FIG. 27 is a plan view of a rope inspection device of a crane according to a tenth embodiment of the present invention.

FIG. 28 is an enlarged side view of a boom of a crane according to an eleventh embodiment of the present invention.

FIG. 29 is a front view of a rope inspection device of the crane according to the eleventh embodiment of the present invention.

FIG. 30 is a side view of the rope inspection device of the crane according to the eleventh embodiment of the present invention.

FIG. 31 is a perspective view of a rope inspection unit of the crane according to the eleventh embodiment of the present invention.

FIG. 32 is an enlarged side view of a boom of a crane according to a twelfth embodiment of the present invention.

FIG. 33 is a side view of a crane according to a thirteenth embodiment of the present invention.

FIG. 34 is a side view of the crane according to the thirteenth embodiment of the present invention.

FIG. 35A is a side view illustrating a posture of a rope inspection unit in the crane according to the thirteenth embodiment of the present invention.

FIG. 35B is a side view illustrating a posture of the rope inspection unit in the crane according to the thirteenth embodiment of the present invention.

FIG. 36 is a front view of a rope inspection device of the crane according to the thirteenth embodiment of the present invention.

FIG. 37A is a process diagram illustrating an attachment procedure of the support unit of the rope inspection device of the crane according to the thirteenth embodiment of the present invention.

FIG. 37B is a process diagram illustrating the attachment procedure of the support unit of the rope inspection device of the crane according to the thirteenth embodiment of the present invention.

FIG. 37C is a process diagram illustrating the attachment procedure of the support unit of the rope inspection device of the crane according to the thirteenth embodiment of the present invention.

FIG. 37D is a process diagram illustrating the attachment procedure of the support unit of the rope inspection device of the crane according to the thirteenth embodiment of the present invention.

FIG. 37E is a process diagram illustrating the attachment procedure of the support unit of the rope inspection device of the crane according to the thirteenth embodiment of the present invention.

FIG. 38 is a front view of a rope inspection device of a crane according to a fourteenth embodiment of the present invention.

FIG. 39 is a plan view of the rope inspection device of the crane according to the fourteenth embodiment of the present invention.

FIG. 40 is a front view of a rope inspection device of a crane according to a fifteenth embodiment of the present invention.

### DESCRIPTION OF EMBODIMENTS

### First Embodiment

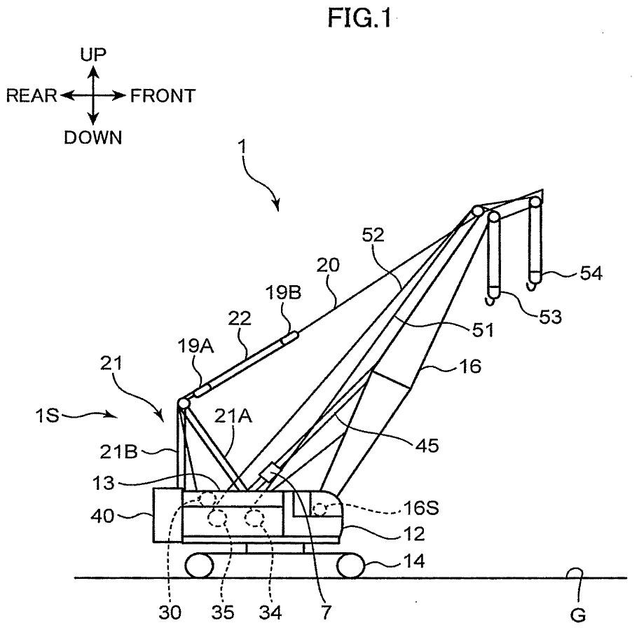

Embodiments of the present invention will be described below with reference to the drawings. FIG. 1 is a side view of a crane 1 (work machine) according to a first embodiment of the present invention. Note that, in FIG. 1, a direction orthogonal to the paper surface corresponds to a left-right direction.

The crane 1 includes an upper slewing body 12 (main body frame), a lower travelling body 14, a boom 16 (rising/lowering body), a lower spreader 19A, an upper spreader 19B, a pair of left and right boom guy lines 20, a gantry 21, a boom raising/lowering rope 22, a boom raising/lowering winch 30, a main winding winch 34, an auxiliary winding winch 35, a counterweight 40, and a pair of left and right backstops 45. Furthermore, the crane 1 includes a main winding rope 51, an auxiliary winding rope 52, a main hook 53, and an auxiliary hook 54. Note that, in the following description, the pair of left and right members has the left and right structures that are same, and therefore one of the left and right structures will be described.

The upper slewing body 12 constitutes a crane body (machine body) of the crane 1, and is supported by the lower travelling body 14 so as to be slewable about a slewing center axis extending in an up-down direction. The lower travelling body 14 can travel on a travelling surface such as a ground G.

The boom 16 is supported by the upper slewing body 12 to be capable of rising/lowering. In the present embodiment, a boom foot 16S included in a base end of the boom 16 is turnably supported by a shaft support part, not illustrated, of the upper slewing body 12. As an example, the boom 16 is a so-called lattice type, and is configured by coupling a plurality of boom members to each other. The structure of the boom 16 is not limited to this, and may be a box-like structure, a telescopic structure, or the like. In addition, the position for supporting the boom 16 is not limited to the front side of the upper slewing body 12, and may be the rear side. The pair of left and right backstops 45 is supported on the back surface of the boom 16. These backstops 45 support the boom 16 from behind by each abutting against the upper slewing body 12 in a standing posture of the boom 16 (working posture of the crane 1). By this abutment, the backstop 45 is interposed between the upper slewing body 12 and the boom 16, and restricts the boom 16 from being tilted backward due to strong wind or the like.

The lower spreader 19A is connected to the tip end of the gantry 21 and has a lower sheave block not illustrated. In the lower sheave block, a plurality of sheaves is arrayed in a width direction (left-right direction).

The upper spreader 19B is disposed at a predetermined interval in front of the lower spreader 19A. The upper spreader 19B is connected to a boom tip end via the boom guy line 20. The upper spreader 19B has an upper sheave block not illustrated. In the upper sheave block, a plurality of sheaves is arrayed in the width direction (left-right direction).

The pair of left and right boom guy lines 20 is disposed at intervals to each other in the left-right direction orthogonal to the paper surface of FIG. 1. A rear end of each of the boom guy lines 20 is connected to the upper spreader 19B, and a front end of each of the boom guy lines 20 is removably connected to a tip end of the boom 16. The boom guy line 20 may have any structure such as a guy link (metal plate material), a guy rope, or a guy wire (metal wire material).

The gantry 21 is supported by the upper slewing body 12 at the rear of the boom 16. As illustrated in FIG. 1, the gantry 21 is configured by two structures (a compression member 21A and a tension member 21B) forming a substantially triangular shape between the gantry 21 and the upper slewing body 12. The tension member 21B extends substantially vertically upward from the rear end of the upper slewing body 12. The compression member 21A connects an upper end of the tension member 21B and a substantially center part of the upper slewing body 12 along an oblique direction. The gantry 21 supports the boom 16 from behind so that the boom 16 is capable of rising/lowering.

Note that the upper slewing body 12, the gantry 21, and the backstop 45 constitute a machine body 1S of the present invention.

The boom raising/lowering rope 22 is led out from the boom raising/lowering winch 30, hung on the sheave disposed at the tip end of the tension member 21B, and then wound a plurality of times between the lower sheave block of the lower spreader 19A and the upper sheave block of the upper spreader 19B. Note that the tip end of the boom raising/lowering rope 22 after being wound around the lower sheave block and the upper sheave block is fixed to the tip end (upper end) of the gantry 21.

The boom raising/lowering winch 30 is disposed on the upper slewing body 12. By winding and unwinding the boom raising/lowering rope 22, the boom raising/lowering winch 30 changes the distance between the lower sheave block of the lower spreader 19A and the upper sheave block of the upper spreader 19B, and raises/lowers the boom 16 while turning the boom 16 relative to the gantry 21.

The main winding winch 34 (winch) winds up and winds down a load to be suspended by the main winding rope 51 (suspended load rope). Note that, as illustrated in FIG. 1, the main winding rope 51 is disposed to extend obliquely forward and upward from the main winding winch 34. In this main winding, a main winding point sheave is provided at the tip end of the boom 16. The main hook 53 connected to the load to be suspended is coupled to the main winding rope 51 led out from the main winding winch 34 and suspended from the main winding point sheave. The main hook 53 is thus hoisted and lowered when the main winding winch 34 winds up and releases the main winding rope 51.

Similarly, the auxiliary winding winch 35 (winch) winds up and winds down the load to be suspended by the auxiliary winding rope 52 (rope). Regarding the auxiliary winding, an auxiliary winding point sheave is provided at the tip end of the boom 16. The auxiliary hook 54 connected to the load to be suspended is coupled to the auxiliary winding rope 52 led out from the auxiliary winding winch 35 and suspended from an auxiliary winding point. When the auxiliary winding winch 35 winds up and releases the auxiliary winding rope 52, the auxiliary hook 54 for a load coupled to a terminal end of the auxiliary winding rope 52 is hoisted or lowered.

Further, the counterweight 40 is a weight loaded on the rear of the upper slewing body 12 in order to adjust the balance of the crane 1.

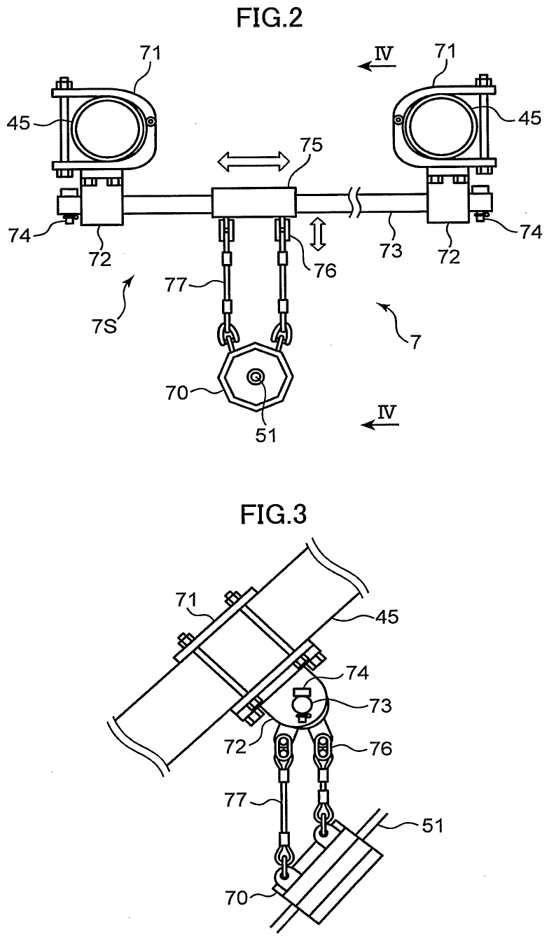

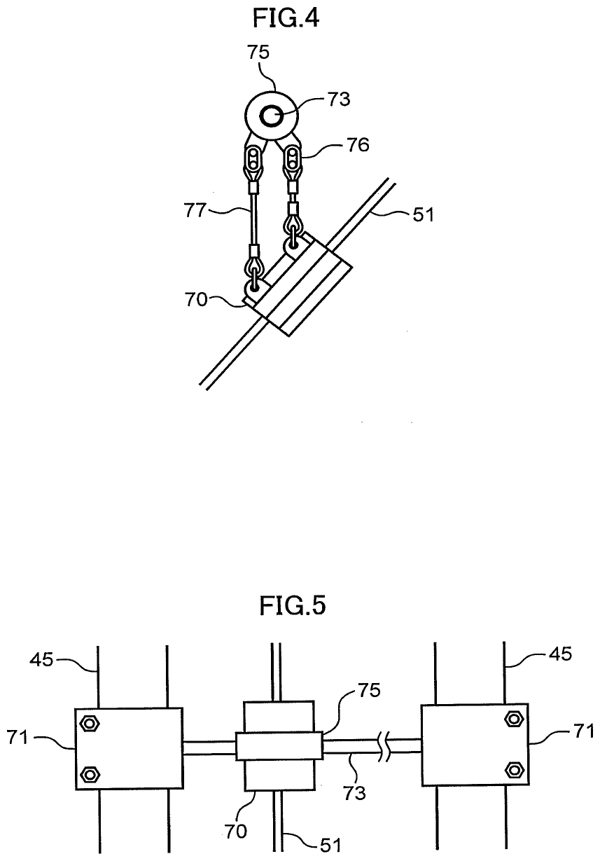

The crane 1 further includes a rope inspection device 7. FIG. 2 is a front view of the rope inspection device 7 of the crane 1 according to the present embodiment. FIGS. 3, 4, and 5 are a side view, a side cross-sectional view, and a plan view of the same. Note that FIG. 4 corresponds to a cross section taken along line IV-IV in FIG. 2.

In the present embodiment, the rope inspection device 7 is provided on the backstop 45, and inspects the degree of deterioration and damage of the main winding rope 51. The rope inspection device 7 is detachable from the backstop 45. The rope inspection device 7 has a rope deterioration detector 70 (rope inspection unit) and a support unit 7S (FIG. 2).

The rope deterioration detector 70 can inspect a deterioration state of the main winding rope 51. In the present embodiment, the rope deterioration detector 70 has a cylindrical shape, and receives the main winding rope 51 in its cylindrical internal space. The rope deterioration detector 70 generates a magnetic field in the internal space, and detects deterioration of the main winding rope 51 by a change in the magnetic field. At this time, since the rope deterioration detector 70 has a tubular shape, the state of the entire circumference of the rope 52 can be measured. An inner peripheral surface of the rope deterioration detector 70 may be attached with a resin member or the like for enhancing the slidability of the main winding rope 51. Note that the mechanism by which the rope deterioration detector 70 detects deterioration of the main winding rope 51 is not limited to the above magnetic one, and may be a mechanical one or an optical one. In addition, the rope deterioration detector 70 is not limited to a tubular shape, and may have a plate shape, a rectangular parallelepiped shape, or the like disposed to face the main winding rope 51.

The support unit 7S is attached to the backstop 45 (attachment target portion). The support unit 7S supports the rope deterioration detector 70 so that the rope deterioration detector 70 can follow the movement of the main winding rope 51. In particular, the support unit 7S supports the rope deterioration detector 70 so as to be able to follow the movement of the main winding rope 51 in the direction intersecting the direction in which the main winding rope 51 extends. The support unit 7S has a pair of left and right clamp parts 71, a pair of left and right pin support members 72, a holder support pin 73 (support pin), a pair of left and right retaining portions 74, a holder 75, four rope layer change handling links 76, and four detector support chains 77.

The clamp part 71 is a member for fixing the rope inspection device 7 to the left and right backstops 45. As illustrated in FIG. 2, each clamp part 71 has a U shape that receives the backstop 45 therein, and is attached to the backstop 45 by fixing both ends thereof with fixing bolts. With the structure of the clamp part 71, the rope inspection device 7 can be easily attached to the backstop 45 of the existing crane 1 in a short time. Thus, the jig for attaching the rope inspection device 7 on the backstop 45 can be downsized, and the workability of the inspection of the main winding rope 51 can be improved.

Each pin support member 72 is fixed to the bottom surface portion of the clamp part 71. The holder support pin 73 is a pin extending in the left-right direction (horizontal direction) so as to connect the pair of left and right pin support members 72. A hole, not illustrated, into which the holder support pin 73 is inserted is formed in the pin support member 72. The pair of retaining portions 74 is attached to both ends of the holder support pin 73, respectively, and prevents the holder support pin 73 from coming off from each pin support member 72. The holder 75 is attached to the holder support pin 73 between the pair of left and right pin support members 72. A hole, not illustrated, into which the holder support pin 73 is inserted is also opened in the holder 75. The holder 75 is held by the holder support pin 73 so as to be relatively movable with respect to the holder support pin 73 along the direction in which the holder support pin 73 extends, and supports each rope layer change handling link 76.

The four rope layer change handling links 76 are attached to the front, rear, left, and right corners of the holder 75, respectively. Each rope layer change handling link 76 is formed with an elongated hole extending in the up-down direction. Each detector support chain 77 has an upper end connected to a lower end of the rope layer change handling link 76 and a lower end connected to the rope deterioration detector 70. Note that the upper end of the detector support chain 77 has a pin structure that is inserted into the elongated hole of the rope layer change handling link 76, and as a result, the detector support chain 77 can move up and down relative to the rope layer change handling link 76. In this case, the detector support chain 77 functions as an up-down movement allowing unit of the present invention that allows the rope deterioration detector 70 to move up and down following the movement of the main winding rope 51 in the up-down direction.

Further, as illustrated in FIG. 3, the two detector support chains 77 on the front side are set to be shorter than the two detector support chains 77 on the rear side. As a result, the front detector support chain 77 and the rear detector support chain 77 (a pair of front and rear support links) support the rope deterioration detector 70 in an inclined manner along the direction in which the main winding rope 51 extends.

Note that the clamp part 71, the pin support member 72, the holder support pin 73, the retaining portion 74, and the holder 75 constitute a support mechanism of the present invention supported by the backstop 45 (machine body 1S). The rope layer change handling link 76 and the detector support chain 77 constitute a support link of the present invention. The support link is suspended from the support mechanism and swingably supports the rope deterioration detector 70.

As described above, in the present embodiment, the support unit 7S supports the rope deterioration detector 70 so that the rope deterioration detector 70 capable of inspecting the deterioration state of the main winding rope 51 can follow the movement of the main winding rope 51. The support unit 7S is attached to the machine body 1S (backstop 45) of the work machine. With such a configuration, even when the position of the main winding rope 51 changes with the operation of the crane 1, the rope deterioration detector 70 can move following the main winding rope 51, so that the inspection of the main winding rope 51 can be stably performed.

In particular, in the present embodiment, the backstop 45 on the upper slewing body 12 can be used to stably support the rope inspection unit.

Further, in the present embodiment, since the rope layer change handling link 76 and the detector support chain 77 swingably support the rope deterioration detector 70, the rope deterioration detector 70 can easily move following the main winding rope 51 even when the position of the main winding rope 51 changes.

Furthermore, in the present embodiment, since the lengths of the front and rear detector support chains 77 are set to be different, the posture of the rope deterioration detector 70 can be maintained in an inclined manner along the direction in which the main winding rope 51 extends from the main winding winch 34.

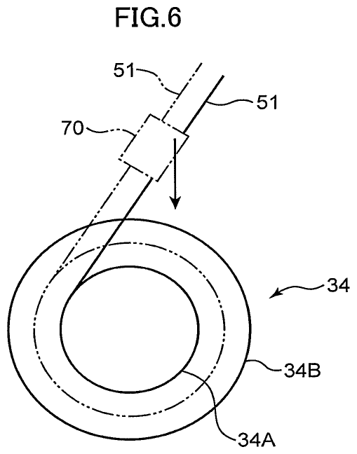

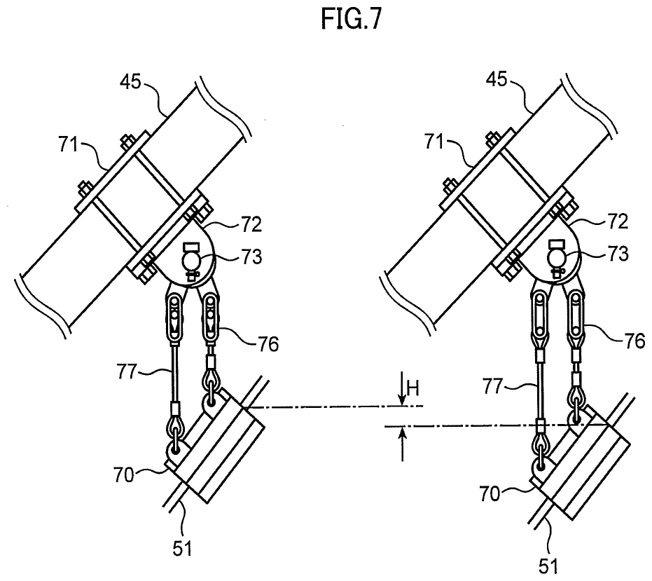

FIG. 6 is a schematic side view illustrating the main winding rope 51 extending from the main winding winch 34. FIG. 7 is a side view comparing two states of the rope inspection device 7. Referring to FIG. 6, the main winding winch 34 has a drum shaft portion 34A and a drum flange 34B. The main winding rope 51 is wound so as to form a plurality of layers on the drum shaft portion 34A. When the main winding winch 34 winds up or winds out the main winding rope 51, the layer of the main winding rope 51 on the main winding winch 34 changes, so that the position of the main winding rope 51 led out changes up and down as indicated by a chain line and a solid line in FIG. 6. At this time, if the upper and lower positions of the rope deterioration detector 70 are fixed, it is difficult to stably detect the deterioration state of the main winding rope 51. However, in the present embodiment, as illustrated in FIG. 7, the detector support chain 77 can move up and down relative to the rope layer change handling link 76. As a result, the position of the rope deterioration detector 70 in the up-down direction can be changed by the height H.

As described above, in the present embodiment, the rope layer change handling link 76 and the detector support chain 77 can allow the rope deterioration detector 70 to move up and down following the movement of the main winding rope 51 in the up-down direction. Thus, even if the position of the main winding rope 51 changes up and down with the operation of the crane 1, the rope deterioration detector 70 can move following the main winding rope 51. Accordingly, the rope deterioration detector 70 can stably detect the deterioration state of the main winding rope 51 while the main winding winch 34 unwinds or winds the main winding rope 51.

Further, in the present embodiment, even when the main winding rope 51 is pulled left and right, the holder 75 can move along the holder support pin 73. Thus, even if the position of the main winding rope 51 changes in the left-right direction with the operation of the crane 1, the rope deterioration detector 70 can move following the main winding rope 51.

Note that inspection of the main winding rope 51 by the rope inspection device 7 may be performed during the operation of the crane 1, or may be performed after end or before start of the work. In either case, it is not necessary to cause the boom 16 to tilt with respect to the upper slewing body 12 in order to inspect the main winding rope 51. In addition, in the present embodiment, since it is possible to constantly monitor the main winding rope 51 by the rope inspection device 7, it is possible to prevent damage of the main winding rope 51 due to overlooking from becoming severe as compared with a case of visual inspection and confirmation by the operator. Further, when the work site of the crane 1 is narrow and it is difficult to attach and detach the rope inspection device 7, the rope inspection device 7 can be kept attached to the crane 1.

Further, as described above, the rope inspection device 7 can be easily attached to and detached from the backstop 45 in the pair of left and right clamp parts 71. In particular, since the rope inspection device 7 is attached to the lower portion of the backstop 45, the operator can easily attach and detach the rope inspection device 7 while standing on the upper slewing body 12. Thus, when it is not necessary to inspect the deterioration state of the main winding rope 51, the rope inspection device 7 may be removed from the backstop 45, and the rope inspection device 7 may be attached to the backstop 45 when the operation of the crane is not performed to detect the deterioration state of the main winding rope 51. As a result, the weight of the crane 1 itself can be reduced during the operation of the crane 1. Further, since the rope inspection device 7 can be removed also when the crane 1 is disassembled and transported, each member of the crane 1 can be transported while satisfying the transport weight limit. Note that, in order to easily attach the main winding rope 51 inside the rope deterioration detector 70, it is desirable that the rope deterioration detector 70 be separable into two members.

### Second Embodiment

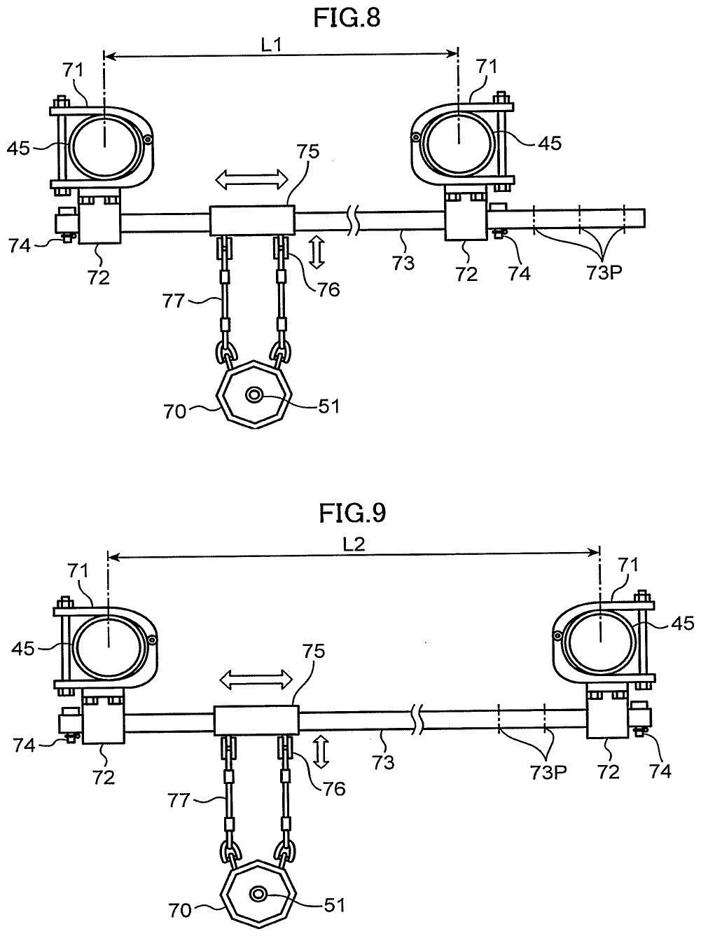

Next, a second embodiment of the present invention will be described. Note that, in the present embodiment, differences from the first embodiment will be mainly described. FIGS. 8 and 9 are front views of a rope inspection device 7 of a crane 1 according to the present embodiment. In the drawings, members having the same functions and structures as those of the first embodiment are denoted by the same reference numerals. The same applies to each embodiment described later.

In the present embodiment, a plurality of length adjusting holes 73P is formed at one end of the holder support pin 73. A retaining portion 74 can be attached to each of the length adjusting holes 73P. As illustrated in FIG. 8, when the retaining portion 74 is attached to the innermost length adjusting hole 73P, the rope inspection device 7 can be attached to the crane 1 in which the width of the left and right backstops 45 is L1. On the other hand, as illustrated in FIG. 9, when the retaining portion 74 is attached to the outermost length adjusting hole 73P, the rope inspection device 7 can be attached to the crane 1 in which the width of the left and right backstops 45 is L2. Note that, when the intermediate length adjusting hole 73P is used, the rope inspection device 7 can be attached in a further variety of cranes 1.

As described above, in the present embodiment, the support mechanism of the rope inspection device 7 further includes the pair of left and right clamp parts 71 (attachment portions) attached to the backstop 45, and the plurality of length adjusting holes 73P (width adjusting parts) capable of adjusting the width of the pair of left and right clamp parts 71 in the left-right direction. With such a configuration, the width of the left and right clamp parts 71 is adjusted according to the width dimension in the left-right direction of the machine body 1S represented by the backstop 45, and the rope inspection device 7 can be easily attached to various types of backstops 45.

### Third Embodiment

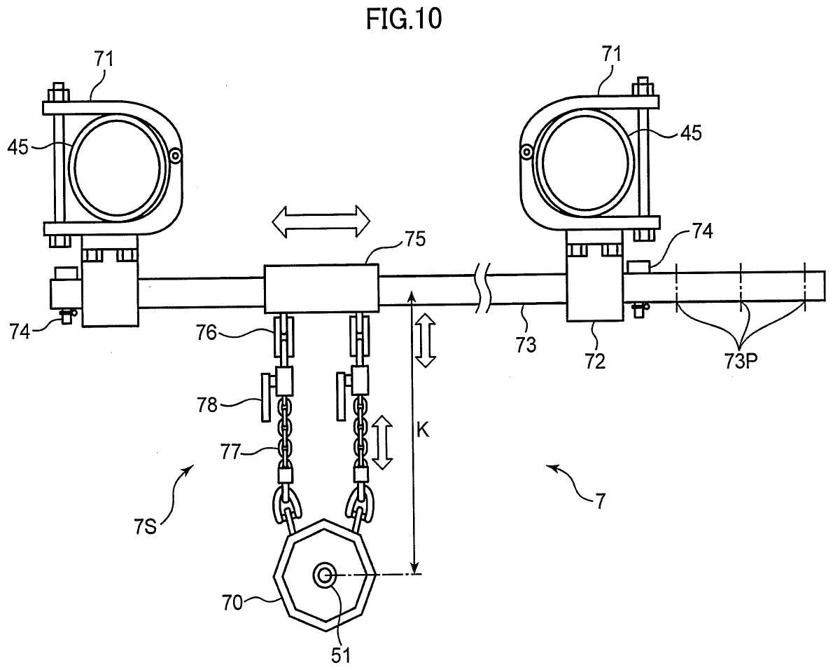

Next, a third embodiment of the present invention will be described. FIG. 10 is a front view of a rope inspection device 7 of a crane 1 according to the present embodiment. In the present embodiment, the support unit 7S of the rope inspection device 7 further includes a pair of left and right length adjusting units 78. The length adjusting unit 78 can adjust the length of the detector support chain 77 between the rope layer change handling link 76 and the rope deterioration detector 70. On the rear side of the detector support chain 77 in FIG. 10, the tip end of the detector support chain 77 folded back at the length adjusting unit 78 is suspended. The length adjusting unit 78 has a lever structure, and when an operator pulls the lever, the length of the detector support chain 77 can be changed. After the length of the detector support chain 77 is adjusted, the length of the detector support chain 77 is fixed when the operator returns the lever.

As described above, in the present embodiment, the length adjusting unit 78 adjusts the length of the detector support chain 77, thereby adjusting the position of the rope deterioration detector 70 in the up-down direction with respect to the holder support pin 73 (relative height K in FIG. 10). In other words, the length adjusting unit 78 functions as an up-down position adjustment unit capable of adjusting the position (height) of the rope deterioration detector 70 in the up-down direction with respect to the upper slewing body 12. With such a configuration, the position of the rope deterioration detector 70 in the up-down direction can be easily adjusted according to the position of the main winding winch 34 and the position of the main winding rope 51 led out from the main winding winch 34.

### Fourth Embodiment

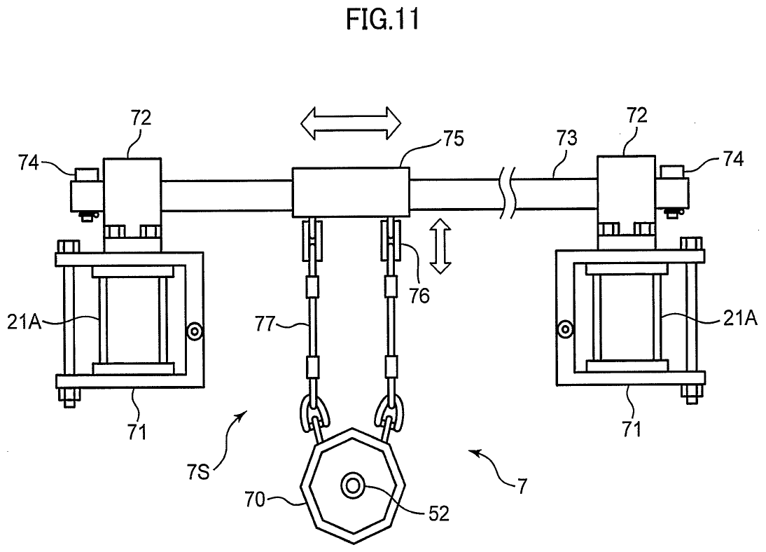

Next, a fourth embodiment of the present invention will be described. FIGS. 11, 12, and 13 are a front view, a side view, and a plan view of a rope inspection device 7 of a crane according to the present embodiment. In the present embodiment, the rope inspection device 7 is attached to a pair of left and right compression members 21A (attachment target portions). The rope deterioration detector 70 of the rope inspection device 7 detects a deterioration state of the auxiliary winding rope 52 led out from the auxiliary winding winch 35.

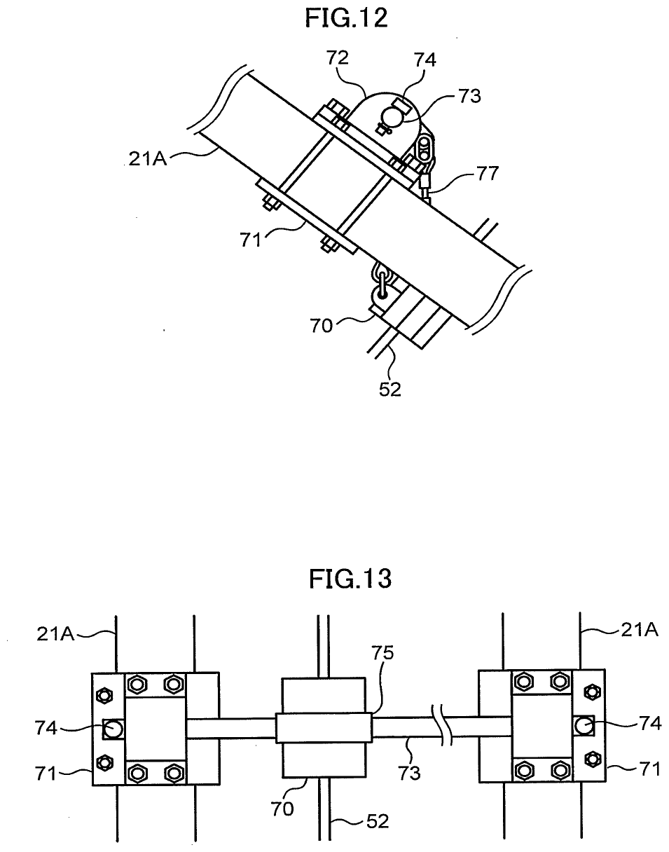

As illustrated in FIG. 11, each of the pair of left and right compression members 21A of the gantry 21 is a box-shaped member having a rectangular cross section. Thus, in the present embodiment, the clamp part 71 also has a U-shaped (square-shaped U-shaped) cross section capable of accommodating the compression member 21A, and the opening is closed by a bolt, whereby the clamp part 71 is fixed to the compression member 21A. As a result, in FIG. 13, the holder 75 can move left and right along the holder support pin 73 stretched between the pair of left and right compression members 21A. As illustrated in FIGS. 12 and 13, the rope deterioration detector 70 supported by the rope layer change handling link 76 and the detector support chain 77 from the holder 75 accommodates the auxiliary winding rope 52 therein and detects a deterioration state thereof.

As described above, in the present embodiment, the compression member 21A of the gantry 21 is erected on the upper slewing body 12 behind the boom 16, and functions as a rear support body that supports the boom 16 from behind. Then, the support unit 7S of the rope inspection device 7 is attached to the compression member 21A. With such a configuration, the rope deterioration detector 70 can be supported using the compression member 21A on the upper slewing body 12. In particular, the compression member 21A and the tension member 21B of the gantry 21 have high rigidity and strength to support the boom 16, and thus it is possible to stably support the rope deterioration detector 70. Note that the rear support body supporting the boom 16 behind the boom 16 is not limited to the gantry 21, and may be a mast.

Also in the present embodiment, since the rope inspection device 7 is attached to the lower portion of the compression member 21A, the operator can easily attach and detach the rope inspection device 7 while standing on the upper slewing body 12.

### Fifth Embodiment

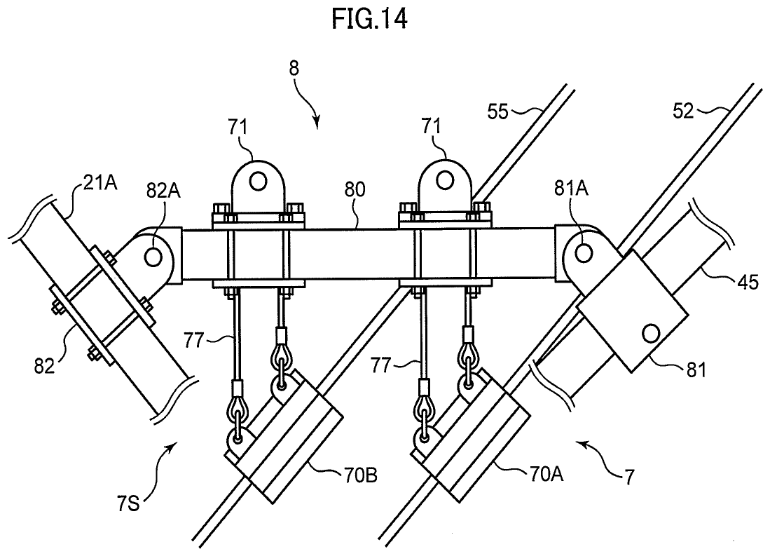

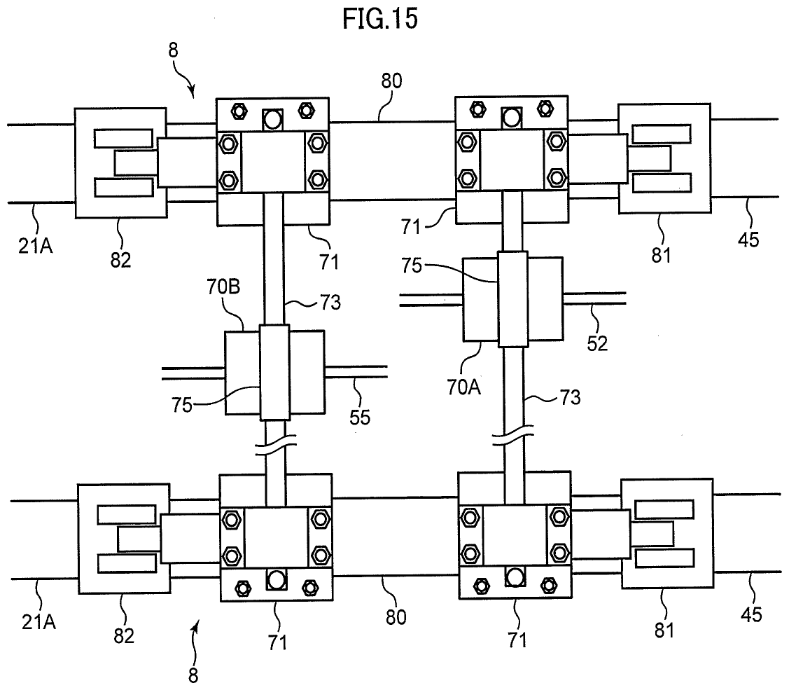

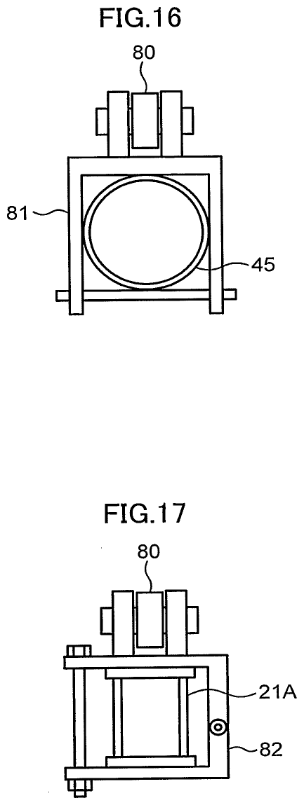

Next, a fifth embodiment of the present invention will be described. FIGS. 14 and 15 are a side view and a plan view of a rope inspection device 7 of a crane according to the present embodiment. FIGS. 16 and 17 are cross-sectional views of a clamp part of the rope inspection device 7 of the crane 1 according to the present embodiment.

In the present embodiment, the backstop 45 extending obliquely forward and upward from the upper slewing body 12 and the compression member 21A extending obliquely backward and upward from the upper slewing body 12 cooperate to support the rope inspection device 7. Specifically, the machine body 1S of the crane 1 further includes a pair of left and right bridging portions 8 (attachment target portions). Each bridging portion 8 is disposed above the upper slewing body 12 so as to connect the backstop 45 and the compression member 21A along the front-rear direction. Each bridging portion 8 has an intermediate portion 80 and clamp parts 81 and 82 disposed respectively at both ends of the intermediate portion 80. The clamp part 81 is attached to the backstop 45, and the clamp part 82 is attached to the compression member 21A. As illustrated in FIG. 16, the clamp part 81 has a shape capable of accommodating the cylindrical backstop 45, and as illustrated in FIG. 17, the clamp part 82 has a shape capable of accommodating the box-shaped compression member 21A.

Referring to FIG. 14, the clamp part 81 has a pin connection part 81A, and the pin connection part 81A turnably supports the front end of the intermediate portion 80. Similarly, the clamp part 82 has a pin connection part 82A, and the pin connection part 82A turnably supports the rear end of the intermediate portion 80.

Referring to FIG. 15, two front and rear holder support pins 73 are supported by pin support members 72 at the intermediate portion 80 of the left and right bridging portions 8. Each of the holder support pins 73 supports the rope deterioration detector 70A and the rope deterioration detector 70B with a structure similar to that of the first embodiment. The rope deterioration detector 70A detects a deterioration state of the auxiliary winding rope 52 led out from the auxiliary winding winch 35, and the rope deterioration detector 70B detects a deterioration state of the third rope 55 led out from the third winch not illustrated.

As described above, in the present embodiment, the rope deterioration detectors 70A and 70B are attached to and supported by the bridging portion 8. Thus, the rope deterioration detectors 70A and 70B can be stably supported using the bridging portion 8 disposed between the backstop 45 on the upper slewing body 12 and the compression member 21A. Further, in the present embodiment, since the dedicated rope deterioration detectors 70A and 70B are disposed on each rope, it is not necessary to move the rope inspection device 7 for inspecting a plurality of ropes. On the other hand, in FIG. 14, only one of the rope deterioration detectors 70A and 70B may be supported by the bridging portion 8.

Also in the present embodiment, since the bridging portion 8 is disposed in the lower portion of the backstop 45 and the compression member 21A, the attachment and detachment work of the rope inspection device 7 can be easily performed in a state where the operator stands on the upper slewing body 12. Note that, also in the present embodiment, the mast may support the rope inspection device 7 together with the backstop 45 instead of the gantry 21 (compression member 21A).

### Sixth Embodiment

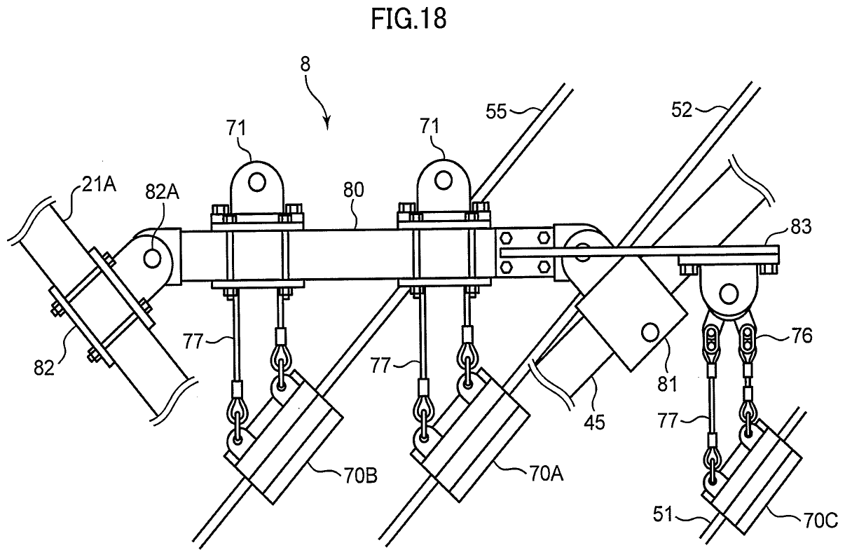

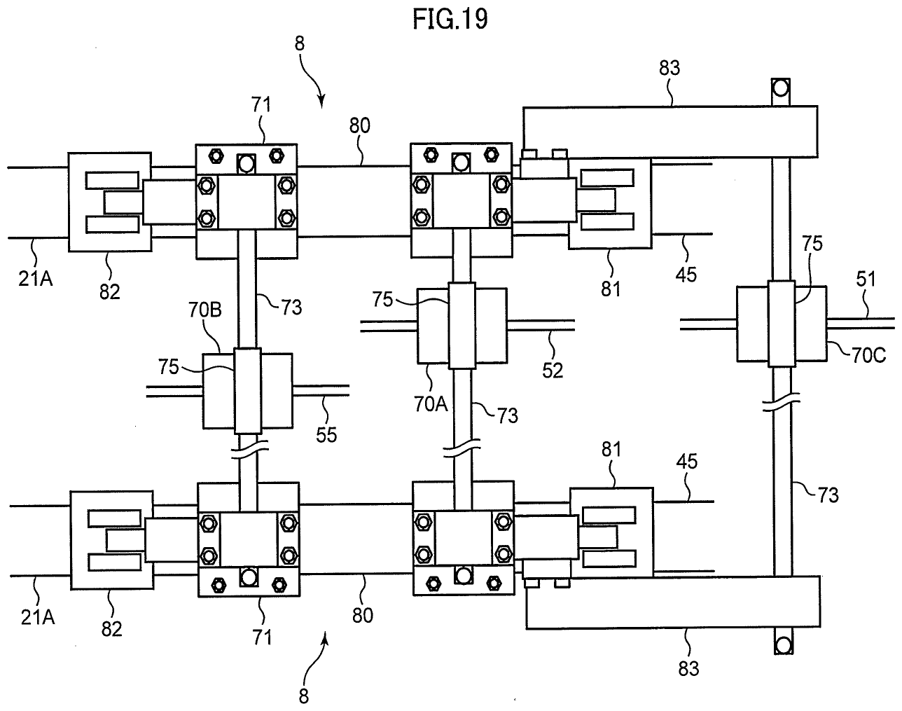

Next, a sixth embodiment of the present invention will be described. FIGS. 18 and 19 are a side view and a plan view of a rope inspection device of a crane according to the present embodiment. In the present embodiment, the pair of left and right bridging portions 8 further has a pair of left and right cantilever members 83 (protrusions). The cantilever member 83 is connected to the intermediate portion 80 located between the backstop 45 and the compression member 21A in the bridging portion 8. The cantilever member 83 is disposed so as to protrude forward from the backstop 45.

As illustrated in FIG. 19, the holder support pin 73 is also supported by front end portions of the pair of left and right cantilever members 83. The holder support pin 73 supports the holder 75, and the holder 75 supports a rope deterioration detector 70C via the rope layer change handling link 76 and the detector support chain 77. In the present embodiment, the rope deterioration detector 70C detects a deterioration state of the main winding rope 51 led out from the main winding winch 34. As described above, in the present embodiment, the rope deterioration detectors 70A and 70B are supported by the intermediate portion 80, and the rope deterioration detector 70C is supported by the cantilever member 83. In such a configuration, the rope deterioration detectors 70 (70A, 70B, and 70C) can be stably supported using the intermediate portion 80 between the backstop 45 and the compression member 21A or the cantilever member 83 (protrusion) protruding forward from the backstop 45.

Note that, also in the present embodiment, at least one of the rope deterioration detectors 70A, 70B, or 70C may be disposed. In addition, the rope deterioration detector may be supported by a cantilever member (protrusion), not illustrated, protruding rearward from the compression member 21A.

### Seventh Embodiment

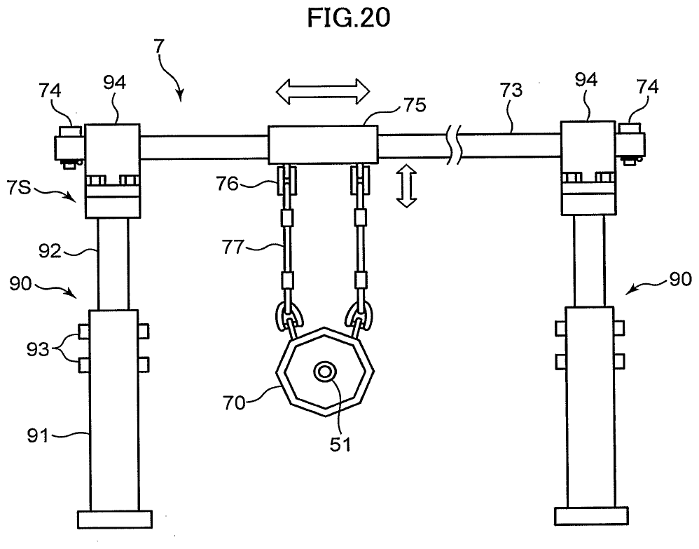

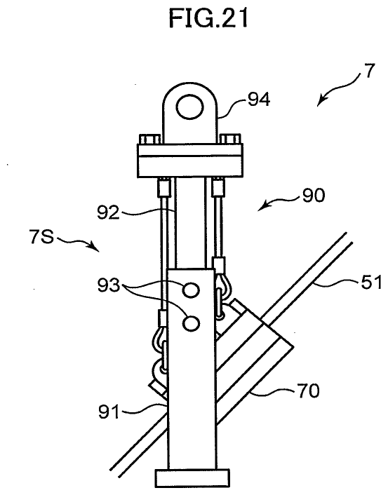

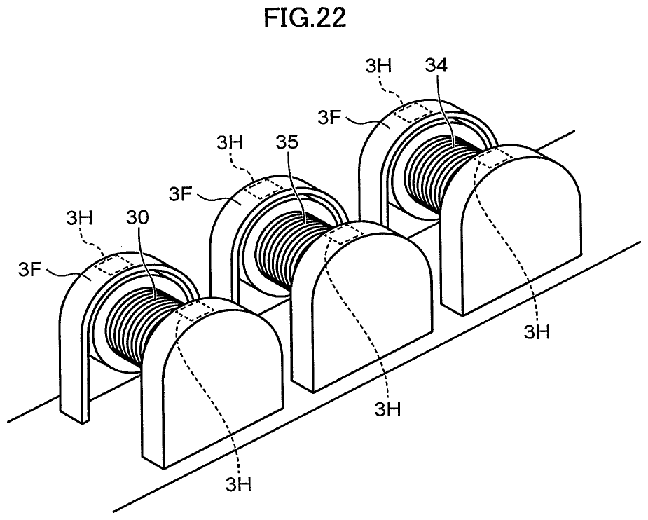

Next, a seventh embodiment of the present invention will be described. FIGS. 20 and 21 are a front view and a side view of a rope inspection device 7 of a crane according to the present embodiment. FIG. 22 is a perspective view illustrating a drum cover 3F on which the rope inspection device 7 of the crane 1 according to the present embodiment is attached.

In the present embodiment, the support unit 7S of the rope inspection device 7 has a pair of left and right support legs 90. Each support leg 90 has a leg main body 91, an expansion/contraction part 92, a fixing pin 93, and a pin support member 94. The leg main body 91 corresponds to a lower end of the support leg 90 and has a tubular shape. The expansion/contraction part 92 is inserted into the tube of the leg main body 91 and extends and contracts in the up-down direction with respect to the leg main body 91. The fixing pin 93 fixes the expansion/contraction part 92 so as to prevent the relative movement of the expansion/contraction part 92 with respect to the leg main body 91. The pin support member 94 is disposed at the upper end of the expansion/contraction part 92 and supports the holder support pin 73.

Referring to FIG. 22, in the present embodiment, the boom raising/lowering winch 30, the main winding winch 34, and the auxiliary winding winch 35 are disposed on the upper slewing body 12 side by side in the front-rear direction. A winch drum of each winch is protected by a pair of left and right drum covers 3F (attachment target portions) disposed on the upper slewing body 12. A leg fixing unit 3H that supports the leg main body 91 of the support leg 90 is disposed on the upper surface of drum cover 3F.

As described above, in the present embodiment, each winch has a rotatable winch drum, and the support unit 7S of the rope inspection device 7 is attached (fixed) to the drum cover 3F that protects the winch drum. With such a configuration, the rope deterioration detector 70 can be stably supported using the drum cover 3F disposed on the upper slewing body 12. Also in the present embodiment, since the rope inspection device 7 is attached to the drum cover 3F on the upper slewing body 12, the operator can easily attach and detach the rope inspection device 7 while standing on the upper slewing body 12. Further, when the rope inspection device 7 is attached to the drum cover 3F as in the present embodiment, it is possible to install the rope inspection device 7 without being affected by rising/lowering and posture changes of the boom 16, the backstop 45, and the gantry 21.

Note that, in the present embodiment, the drum cover 3F in FIG. 22 is disposed between the pair of left and right backstops 45 (FIG. 1) in the left-right direction, in other words, between the pair of left and right compression members 21A. Thus, when the backstop 45 and the compression member 21A change the posture with respect to the upper slewing body 12, the rope inspection device 7 does not become an obstacle, and the space on the upper slewing body 12 can be effectively used.

Note that the pair of support legs 90 of the rope inspection device 7 of FIGS. 20 and 21 may be fixed (attached) on the guard 13 disposed on the upper slewing body 12 of FIG. 1. The guard 13 protects a predetermined device such as an engine on the upper slewing body 12. In such a configuration, the rope deterioration detector 70 can be stably supported using the guard 13 disposed on the upper slewing body 12. Also in this case, the operator can easily perform the attaching and detaching work of the rope inspection device 7 while standing on the upper slewing body 12.

Note that, in FIGS. 20 and 21, the leg main body 91 and the expansion/contraction part 92 may have a cylinder structure exemplified by a hydraulic cylinder, and the expansion/contraction part 92 expands/contracts with respect to the leg main body 91. In this case, the hydraulic cylinder may be expanded and contracted so that the rope deterioration detector 70 can follow the movement of the rope according to the vertical movement of the rope.

### Eighth Embodiment

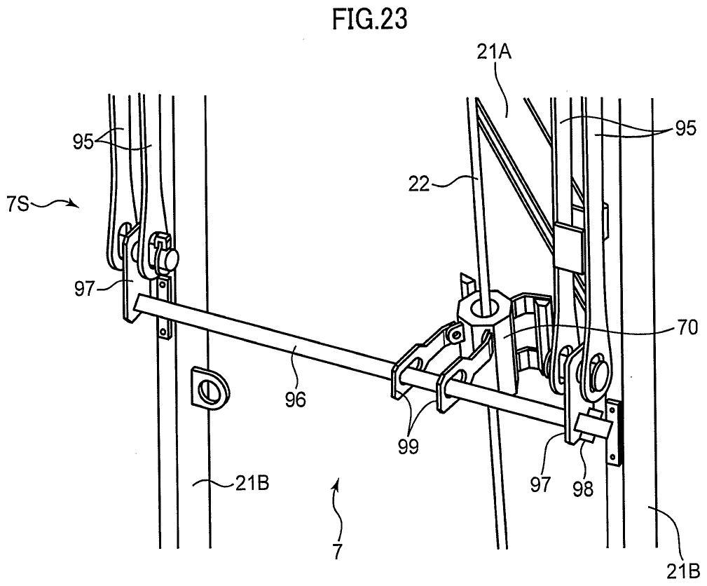

Next, an eighth embodiment of the present invention will be described. FIGS. 23, 24, and 25 are a perspective view, a side view, and a plan view of a rope inspection device of a crane according to the present embodiment. In the present embodiment, the rope inspection device 7 is attached to the tension member 21B (attachment target portion) of the gantry 21 of FIG. 1. Specifically, the support unit 7S of the rope inspection device 7 has a pair of left and right pin support links 95, a holder support pin 96, a pair of left and right fixing members 97, a pair of left and right retaining portions 98, and a pair of left and right connecting arms 99. The rope deterioration detector 70 of the rope inspection device 7 detects a deterioration state of the boom raising/lowering rope 22 led out from the boom raising/lowering winch 30 (FIG. 1).

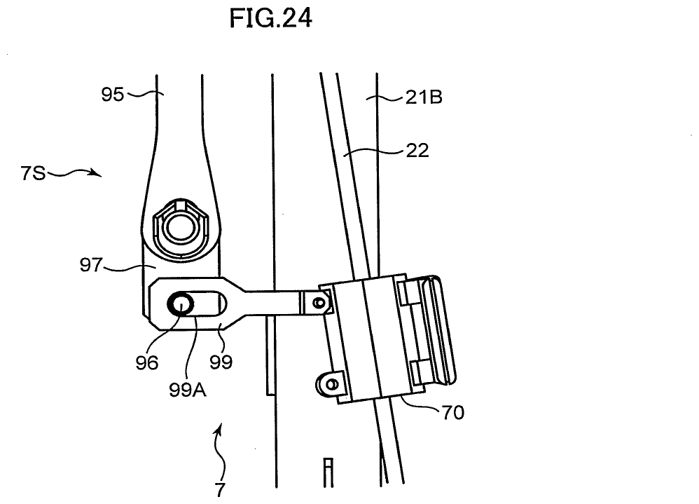

The pair of left and right pin support links 95 is swingably supported by an upper end (top) of the gantry 21 (tension member 21B). The pin support link 95 extends in the up-down direction along the tension member 21B immediately behind the tension member 21B. Each pin support link 95 includes a pair of left and right plate-like members. The fixing member 97 is attached to the lower end portion of the pin support link 95, and the holder support pin 96 is supported by the pair of left and right fixing members 97. The pair of left and right retaining portions 98 prevents the fixing member 97 from coming off from the holder support pin 96 at both ends of the holder support pin 96. The pair of left and right connecting arms 99 is disposed so as to extend rearward from the rope deterioration detector 70. Each connecting arm 99 is formed with a long hole 99A (FIG. 24) that is long in the front-rear direction. By inserting the holder support pin 96 into each of the long holes 99A, the rope deterioration detector 70 is supported by the holder support pin 96 via the pair of left and right connecting arms 99.

In this configuration, the rope inspection device 7 is supported by the gantry 21 (tension member 21B), so that the rope deterioration detector 70 can stably detect the deterioration state of the boom raising/lowering rope 22.

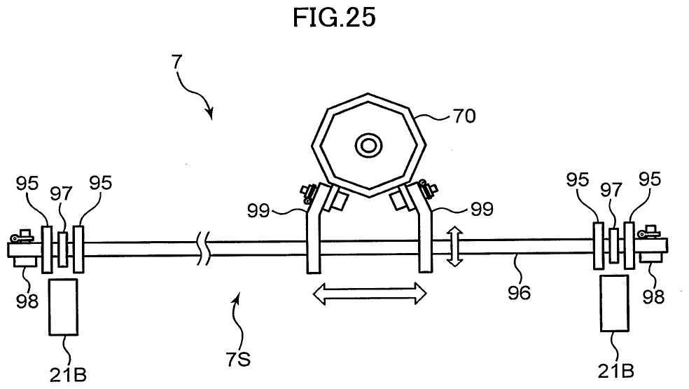

Note that, even if the boom raising/lowering rope 22 is moved in the front-rear direction in the work in which the boom raising/lowering winch 30 winds up and winds out the boom raising/lowering rope 22, the connecting arm 99 can relatively move in the front-rear direction with respect to the holder support pin 96 by the length of the long hole 99A, so that the rope deterioration detector 70 can move in the front-rear direction following the boom raising/lowering rope 22 as indicated by an arrow in FIG. 25. Further, when the boom raising/lowering rope 22 moves left and right in accordance with the unwinding position on the boom raising/lowering winch 30, the pair of left and right connecting arms 99 move left and right along the holder support pin 96, so that the rope deterioration detector 70 can move left and right so as to follow the boom raising/lowering rope 22 as indicated by the arrow in FIG. 25. Note that, in another embodiment, by the pin support link 95 swinging back and forth about the top of the gantry 21 as a fulcrum, the rope deterioration detector 70 may follow the forward and backward movement of the boom raising/lowering rope 22.

### Ninth Embodiment

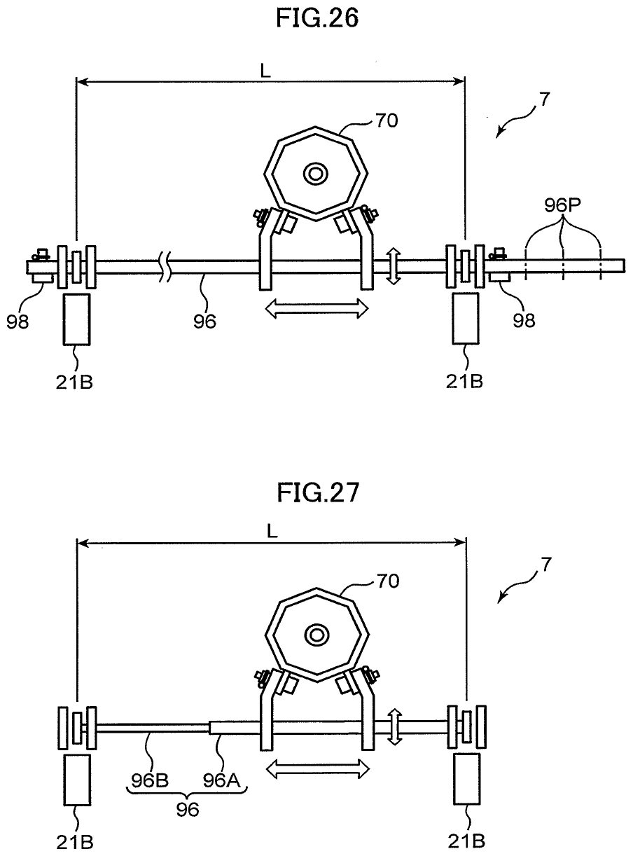

Next, a ninth embodiment of the present invention will be described. FIG. 26 is a plan view of a rope inspection device of a crane according to the present embodiment. The present embodiment is different from the eighth embodiment in that it has a plurality of length adjusting holes 96P at an end of the holder support pin 96. In the case of such a configuration, even if the left and right width of the tension members 21B may be different according to the specification of the crane 1, a left and right width L of the support unit 7S of the rope inspection device 7 can be adjusted according to the width of the tension members 21B, and the rope inspection device 7 can be easily attached to the tension members 21B.

### Tenth Embodiment

Next, a tenth embodiment of the present invention will be described. FIG. 26 is a plan view of a rope inspection device of a crane according to the present embodiment. The present embodiment is different from the eighth embodiment in that the holder support pin 96 has a cylinder structure including a pin main body 96A and an expansion/contraction part 96B. Even in such a configuration, when the left and right width of the tension members 21B is different according to the specification of the crane 1, the left and right width L of the support unit 7S of the rope inspection device 7 is adjusted according to the width of the tension members 21B, and the rope inspection device 7 can be easily attached to the tension members 21B.

### Eleventh Embodiment

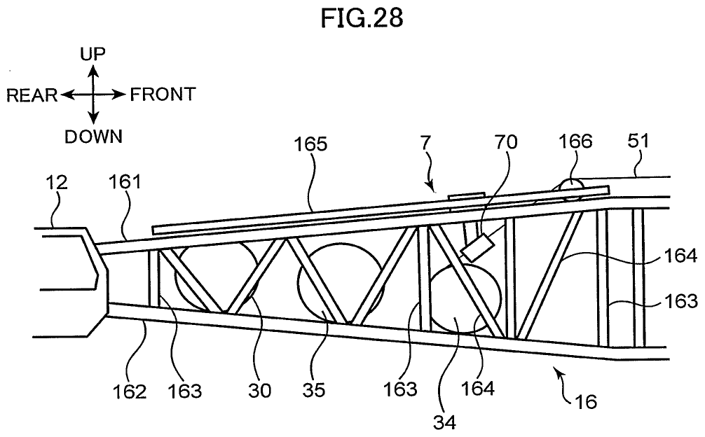

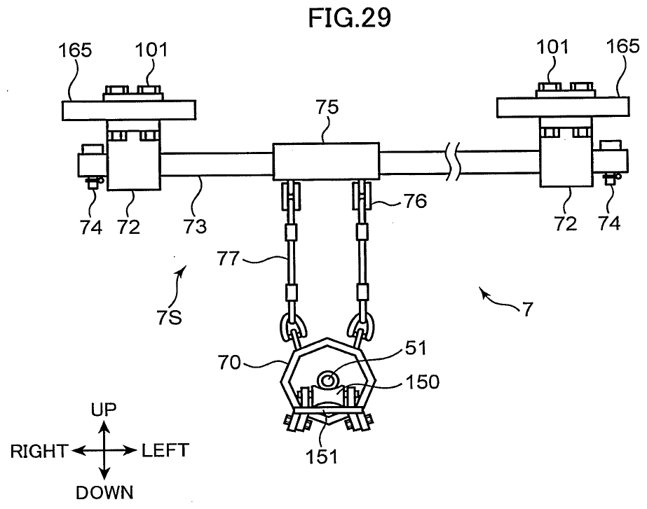

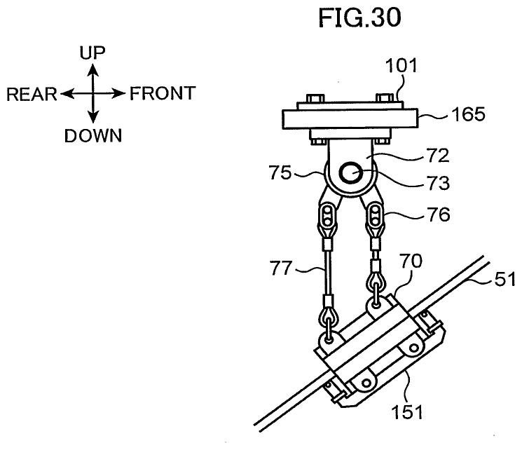

Next, an eleventh embodiment of the present invention will be described. FIG. 28 is an enlarged side view of a boom 16 of a crane 1 according to the present embodiment. FIGS. 29 and 30 are a front view and a side view of a rope inspection device 7 of the crane 1 according to the present embodiment. FIG. 31 is a perspective view of a rope deterioration detector 70 of the crane 1 according to the present embodiment.

FIG. 28 illustrates a state in which the boom 16 is tilted with respect to the upper slewing body 12. The boom 16 has a pair of left and right first main members 161, a pair of left and right second main members 162, a plurality of connecting members 163, a plurality of lattice members 164, a pair of left and right scaffolding members 165 (extending members), and a guide sheave 166.

Each of the first main member 161 and the second main member 162 forms a rectangular cross-sectional shape of the boom 16, and is a member extending in a longitudinal direction thereof at four corners of the boom 16. Note that, in FIG. 28, the first main member 161 and the second main member 162 on the front side of the paper surface appear. The plurality of connecting members 163 connect the first main member 161 and the second main member 162, or connect each of the pair of left and right first main members 161 and the pair of left and right second main members 162. The plurality of lattice members 164 also connect the respective members similar to the plurality of connecting members 163. Note that, each lattice member 164 is a member extending obliquely with respect to the longitudinal direction of the boom 16.

The pair of left and right scaffolding members 165 is disposed along the pair of left and right first main members 161. Each scaffolding member 165 is used when the operator moves on the boom 16. Note that, in the present embodiment, the pair of left and right scaffolding members 165 is disposed more inside in the left-right direction than the pair of left and right first main members 161.

The guide sheave 166 is rotatably supported on a belly surface side (upper surface side in FIG. 28) of the boom 16. The guide sheave 166 has a function of guiding the main winding rope 51 led out from the main winding winch 34 toward the tip end of the boom 16. In the present embodiment, as illustrated in FIG. 28, the winch 30, the main winding winch 34, and the auxiliary winding winch 35 are mounted on the proximal end side (lower boom) of the boom 16. The winch 30 corresponds to a jib winch, a 3rd winch, a miscellaneous winch, and the like.

Furthermore, in the present embodiment, the rope inspection device 7 is attached to the pair of left and right scaffolding members 165. Specifically, as illustrated in FIG. 29, the support unit 7S of the rope inspection device 7 has a pair of left and right scaffolding fixing parts 101. Each scaffolding fixing part 101 is a member for fixing the pin support member 72 of the support unit 7S to the scaffolding member 165. Each scaffolding fixing part 101 has a plurality of bolts. The bolt is inserted into a bolt hole, not illustrated, formed in the scaffolding member 165 and fastened to the pin support member 72. As a result, the support unit 7S is supported by the scaffolding members 165 on both left and right sides of the boom 16. Therefore, the rope deterioration detector 70 can be stably supported without falling off using the boom 16 having high rigidity.

Further, as illustrated in FIG. 28, the rope deterioration detector 70 supported by the support unit 7S (FIG. 29) is disposed inside the boom 16, and can inspect the deterioration state of the main winding rope 51 extending from the main winding winch 34 toward the guide sheave 166. In particular, since the rope deterioration detector 70 does not protrude outside the boom 16, an increase in the height of the boom 16 during transportation is suppressed. Further, the boom 16 can be transported without removing the rope inspection device 7 from the boom 16.

On the other hand, when the boom 16 is raised from the state illustrated in FIG. 28 and the boom 16 is in a posture facing substantially vertically upward, the rope layer change handling link 76 and the detector support chain 77 in FIGS. 29 and 30 are loosened, so that it is temporarily difficult to support the rope deterioration detector 70. In this case, the relative position between the rope deterioration detector 70 and the main winding rope 51 becomes unstable, and the rope deterioration detector 70 may be damaged by contact between the rope deterioration detector 70 and the main winding rope 51.

In order to solve such a problem, in the present embodiment, as illustrated in FIGS. 29 to 31, the support unit 7S has a pair of support rollers 150 (rising/lowering support members) and a roller attachment portion 151. The roller attachment portion 151 is attached to the rope deterioration detector 70 and rotatably supports the pair of support rollers 150.

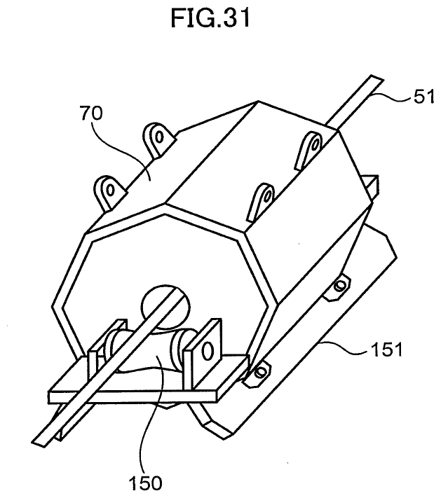

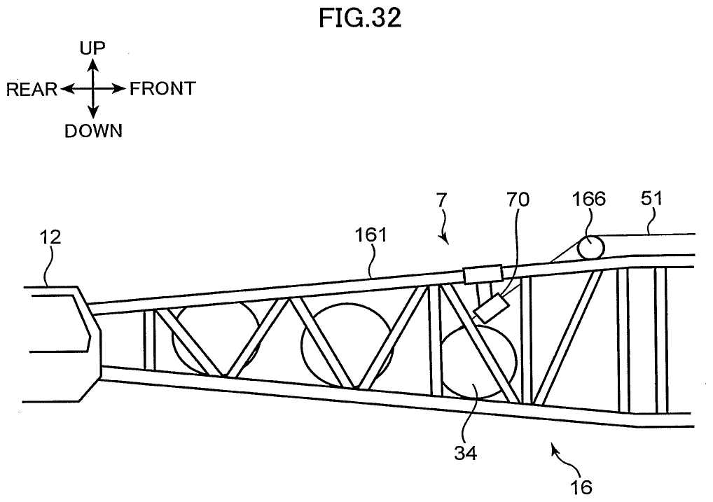

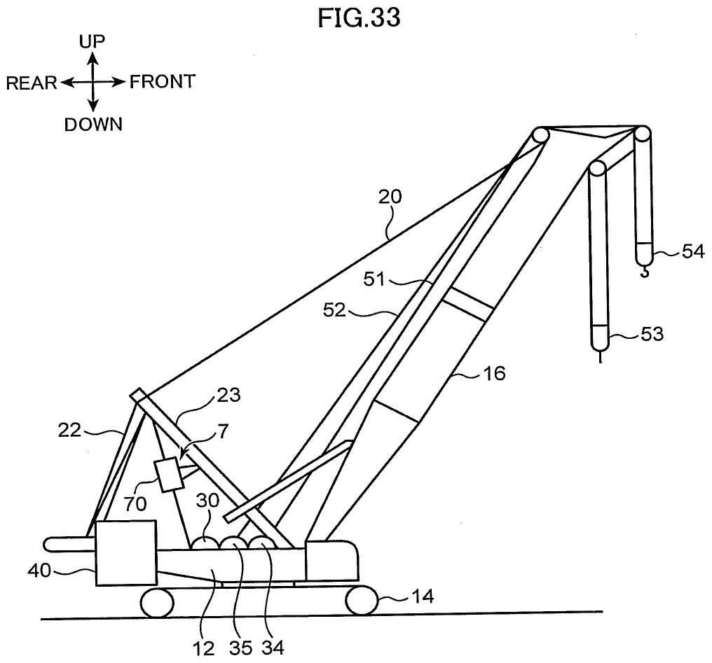

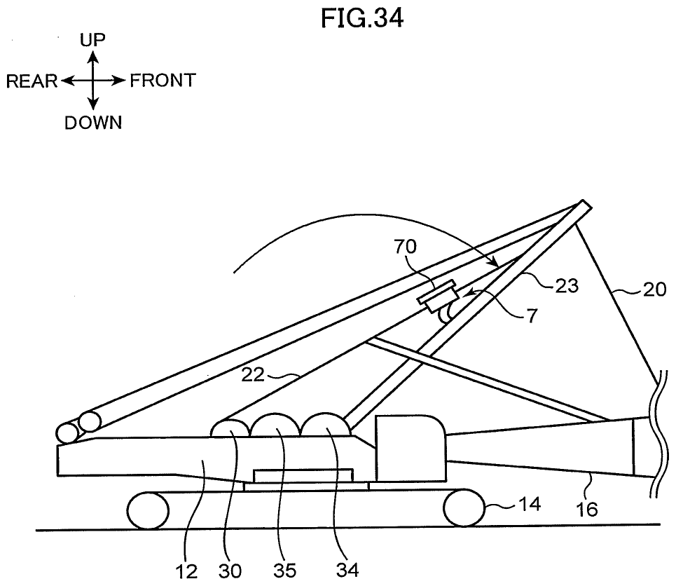

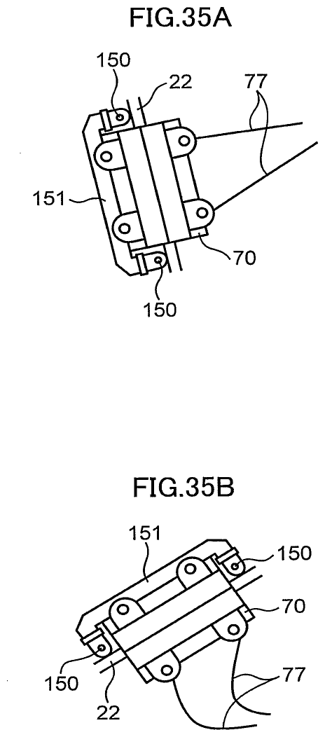

The pair of support rollers 150 is a roller having an outer peripheral surface that supports the main winding rope 51. As illustrated in FIG. 32, the pair of support rollers 150 is disposed on both sides of the rope deterioration detector 70 in the direction in which the main winding rope 51 extends. Note that, in FIG. 32, the support roller 150 on the front side appears. As a result, the support roller 150 comes into contact with the main winding rope 51 at a predetermined rising/lowering angle of the boom 16, whereby the rope deterioration detector 70 and the main winding rope 51 can be prevented from coming into contact with each other (see FIG. 35B). As a result, damage to the rope deterioration detector 70 is suppressed. Further, the maintenance cost of the rope deterioration detector 70 can be reduced. In addition, since the main winding rope 51 can be inspected by the rope deterioration detector 70 in a state where the boom 16 stands up with respect to the upper slewing body 12, it is possible to periodically inspect the main winding rope 51 without requiring removal at the time of transportation, tilting and landing of the boom 16, and it is possible to prevent the main winding rope 51 from becoming serious due to overlooking of the operator or the like.

In particular, in the present embodiment, since the support unit 7S has the rotatable support rollers 150 as a member that supports the main winding rope 51, it is possible to prevent a large load from being applied to the rope and the rope deterioration detector 70 by the outer peripheral surface of the roller coming into contact with the rope. Further, since the support rollers 150 come into contact with the main winding rope 51 on both sides of the rope inspection unit, it is possible to stably prevent contact between the main winding rope 51 and the rope deterioration detector 70.

Further, in the present embodiment, the rope inspection device 7 can be installed using the scaffolding member 165 conventionally attached to the boom 16. Thus, as compared with the case of using a dedicated attachment member other than the scaffolding member 165, it is possible to prevent a significant weight increase due to installation, and it is unnecessary to remove the attachment member at the time of disassembling and transporting the crane 1.

Note that, in the above description, an aspect in which the rope deterioration detector 70 hangs down from the pair of left and right scaffolding members 165 has been described, but an aspect in which the support legs 90 as illustrated in FIGS. 20 and 21 are disposed on the scaffolding member 165 to support the rope deterioration detector 70 may be used. In this case, the relative height of the rope deterioration detector 70 with respect to the boom 16 can be adjusted. Therefore, even when the main winding rope 51 passes through a high position from the scaffolding member 165 on the boom 16, it is possible to stably inspect the main winding rope 51. Furthermore, at the time of transportation of the boom 16, the expansion/contraction part 92 is contracted by changing the position of the fixing pin 93 in FIGS. 20 and 21, and an increase in the transportation dimension of the boom 16 can be prevented.

### Twelfth Embodiment

Next, a twelfth embodiment of the present invention will be described. FIG. 32 is an enlarged side view of a boom 16 of a crane 1 according to the present embodiment. The present embodiment is different from the eleventh embodiment in that the rope inspection device 7 is attached to the pair of left and right first main members 161. In this case, the rope inspection device 7 can be attached to the pair of left and right first main members 161 using the clamp part 71 similar to that in FIG. 10 described above.

As described above, in the present embodiment, since the rope inspection device 7 can be installed on the first main member 161 of the boom 16, it is possible to stably inspect the rope such as the main winding rope 51 even when there is a winch drum such as the main winding winch 34 in the boom 16.

Note that, as a modification, the bridging portion 8 of FIG. 14 may be attached to the pair of lattice members 164 illustrated in FIG. 28, and the rope inspection device 7 may be supported by the bridging portion 8. In addition, the bridging portion 8 may be attached to the pair of connecting members 163. Even when there is no appropriate installation location of the rope inspection device 7 on the first main member 161 or the like, the rope inspection device 7 can be installed using the lattice member 164 or the like, so that the main winding rope 51 can be stably inspected. In particular, as illustrated in FIG. 28, even when the extending directions of the pair of lattice members 164 are different, the support unit 7S can be stably supported by the bridging portion 8.

Further, in the eleventh and twelfth embodiments, the main winding winch 34 and the main winding rope 51 are used, but the rope inspection device 7 is also applicable to other winches illustrated in FIGS. 28 and 32 and other ropes delivered from the winches.

### Thirteenth Embodiment

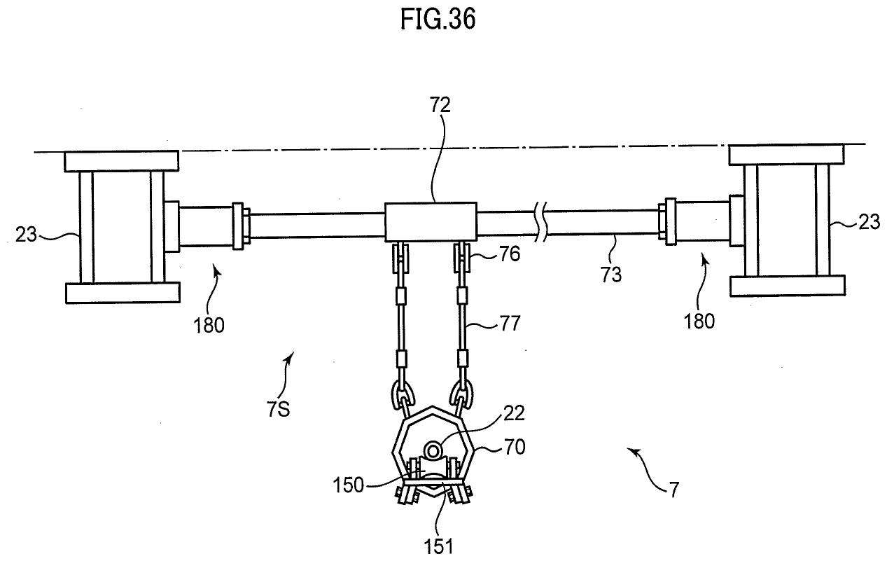

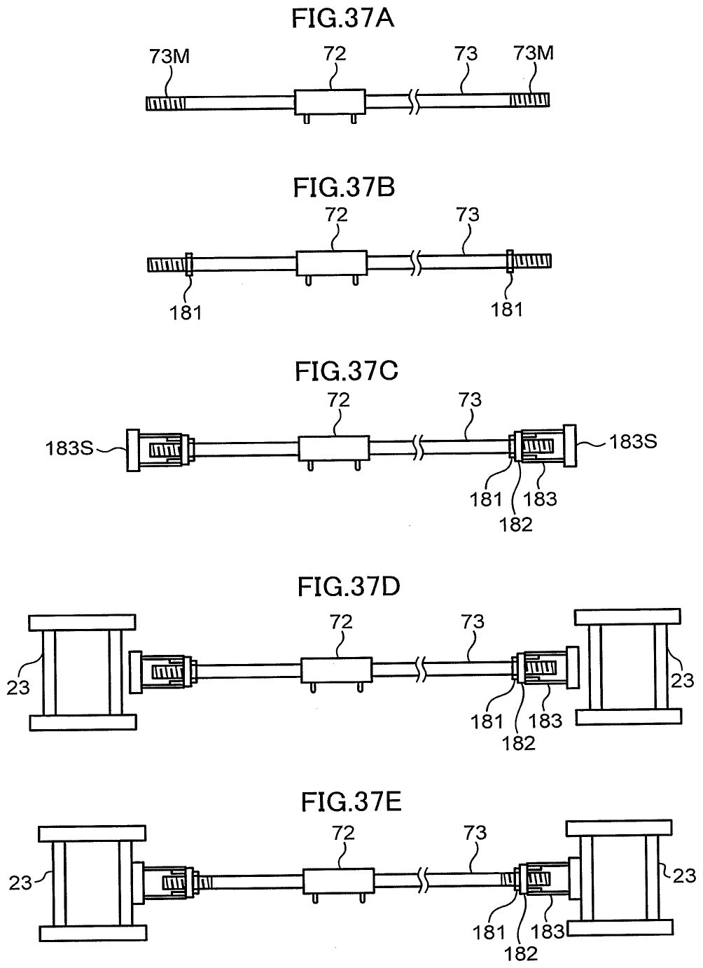

Next, a thirteenth embodiment of the present invention will be described. FIGS. 33 and 34 are side views of a crane 1 according to the present embodiment. FIGS. 35A and 35B are side views illustrating the posture of the rope deterioration detector 70 in the crane according to the present embodiment. FIG. 36 is a front view of the rope inspection device 7 of the crane 1 according to the present embodiment. FIGS. 37A, 37B, 37C, 37D, and 37E are process diagrams illustrating an attachment procedure of the support unit 7S of the rope inspection device 7 of the crane 1 according to the present embodiment.

In the present embodiment, the crane 1 has a pair of left and right masts 23 (rising/lowering body). Each mast 23 is turnably supported by the upper slewing body 12 behind the boom 16, and functions as a support supporting the boom 16 from behind. The boom raising/lowering winch 30 is mounted on the upper slewing body 12, and the boom raising/lowering rope 22 led out from the boom raising/lowering winch 30 is stretched between sheaves, not illustrated, disposed respectively at the tip end of the mast 23 and the rear end of the upper slewing body 12. When the boom raising/lowering winch 30 winds up and winds out the boom raising/lowering rope 22, the boom 16 is raised and lowered integrally with the mast 23.

In the present embodiment, the rope inspection device 7 is supported by the mast 23, and deterioration of the boom raising/lowering rope 22 can be inspected. The mast 23 changes its posture between a standing posture extending rearward and upward from the upper slewing body 12 as illustrated in FIG. 33 and a tilting posture extending forward and upward from the upper slewing body 12 as illustrated in FIG. 34. Note that the mast 23 can be tilted further downward than in FIG. 34. While the rope deterioration detector 70 is supported by the detector support chain 77 in the standing posture of the mast 23 as illustrated in FIG. 35A, the detector support chain 77 is loosened when the mast 23 is in the tilting posture as illustrated in FIG. 35B, so that the position of the rope deterioration detector 70 may become unstable. Thus, also in the present embodiment, the support unit 7S of the rope inspection device 7 has the support rollers 150 and the roller attachment portion 151. Therefore, even in the posture as illustrated in FIG. 35B, the support rollers 150 come into contact with the boom raising/lowering rope 22, so that the relative position between the rope deterioration detector 70 and the boom raising/lowering rope 22 can be stably maintained.

Further, as illustrated in FIG. 36, in the present embodiment, the support unit 7S is attached on inner surfaces of the pair of left and right masts 23. The support unit 7S includes a holder support pin 73 (support pin), and further has a pair of left and right width adjusting parts 180, as in each of the above embodiments. The width adjusting part 180 can adjust the width of a portion of the support unit 7S attached on the left and right inner surfaces of the mast 23.

Referring to the process diagrams illustrated in the drawings of FIG. 37, each of the left and right width adjusting parts 180 has a nut 181, a washer 182, and an attachment portion 183. In the present embodiment, the attachment portion 183 has a cylindrical shape, and a hole portion for receiving the holder support pin 73 is opened in an axially inner portion thereof.

When the support unit 7S is attached to the pair of left and right masts 23, as illustrated in FIG. 37A, the pin support member 72 supporting the rope deterioration detector 70 is attached to the holder support pin 73. Next, as illustrated in FIG. 37B, nuts 181 are attached to deep sides of screw portions 73M on both sides of the holder support pin 73. Then, as illustrated in FIG. 37C, the washer 182 and the attachment portion 183 are inserted into the screw portion 73M. Thereafter, as illustrated in FIG. 37D, the holder support pin 73 is disposed between the pair of left and right masts 23. At this time, there is a gap between an abutting portion 183S of the attachment portion 183 and the inner surface of the mast 23. Further, as illustrated in FIG. 37E, when each nut 181 is rotated and moved axially outward, the washer 182 biases the attachment portion 183 axially outward together with the nut 181. As a result, the abutting portion 183S of the attachment portion 183 abuts against the inner surface of the mast 23. Further, by rotating the nut 181 by a predetermined rotation amount, the left and right attachment portions 183 are biased to the mast 23, and the rope inspection device 7 is attached to the mast 23.

As described above, in the present embodiment, the width adjusting part 180 adjusts the interval between the pair of left and right attachment portions 183 in the left-right direction, thereby biasing the attachment portions 183 toward the inner surface of the mast 23. As a result, the rope deterioration detector 70 can be easily attached in accordance with the size between the left and right masts 23. In addition, the holder support pin 73 and each member for attaching the holder support pin 73 are accommodated between the left and right masts 23, and the rope inspection device 7 does not protrude from the left and right masts 23 to the opposite side of the rope deterioration detector 70 as indicated by a one-dot chain line in FIG. 36, so that the degree of freedom of the layout of surrounding members can be increased.

### Fourteenth Embodiment

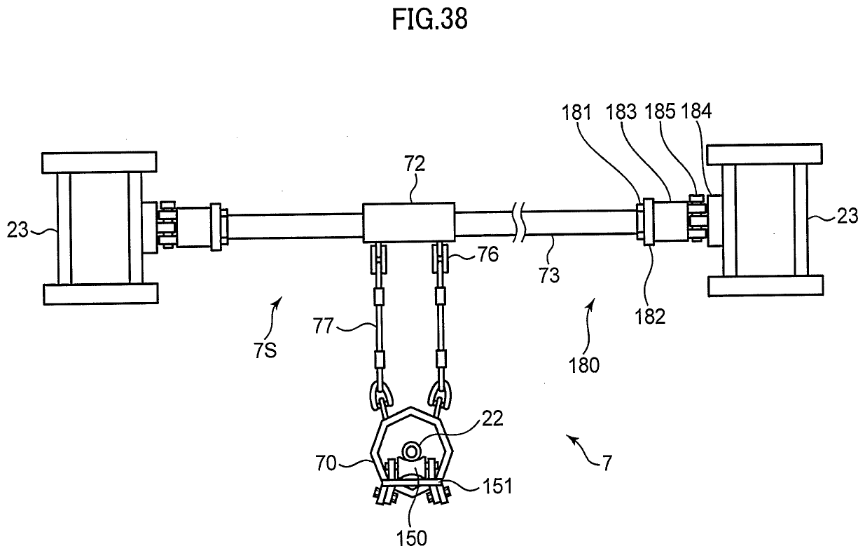

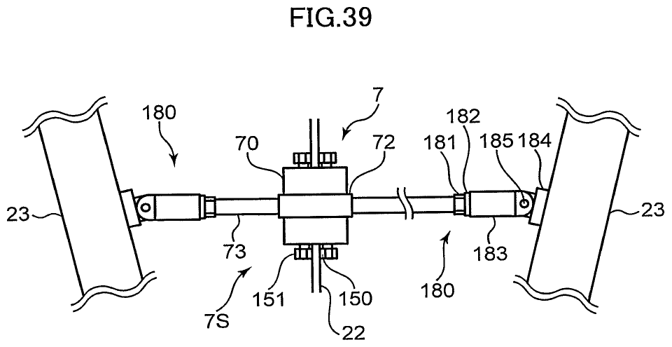

Next, a fourteenth embodiment of the present invention will be described. FIGS. 38 and 39 are a front view and a plan view of a rope inspection device 7 of a crane 1 according to the present embodiment. While an aspect in which the inner surfaces of the left and right masts 23 extend in parallel has been described in the thirteenth embodiment, the inner surfaces of the left and right masts 23 may be inclined in a forward spreading manner as illustrated in FIG. 39.

In the present embodiment, in order to attach the rope inspection device 7 to the left and right masts 23, the width adjusting part 180 of the support unit 7S further has a swing part 184 and a fulcrum part 185. The swing part 184 is attached on an outer side of the attachment portion 183 and abuts against the inner surface of the mast 23. The swing part 184 is supported by the attachment portion 183 so as to be swingable about the fulcrum part 185. The fulcrum part 185 extends in a direction orthogonal to a plane including the left and right masts 23 (a direction orthogonal to the paper surface of FIG. 39). With such a configuration, since the swing part 184 is swingable with respect to the attachment portion 183 at both ends of the holder support pin 73, the support unit 7S can be stably attached even on the inner surface of the inclined mast 23. Note that the other attachment procedure of the support unit 7S is similar to that of the thirteenth embodiment.

Note that, while an aspect in which the rope inspection device 7 is attached to the mast 23 has been described above, when the rope inspection device 7 is attached to another member such as the boom 16, the structure similar to that in FIGS. 38 and 39 can be employed.

### Fifteenth Embodiment

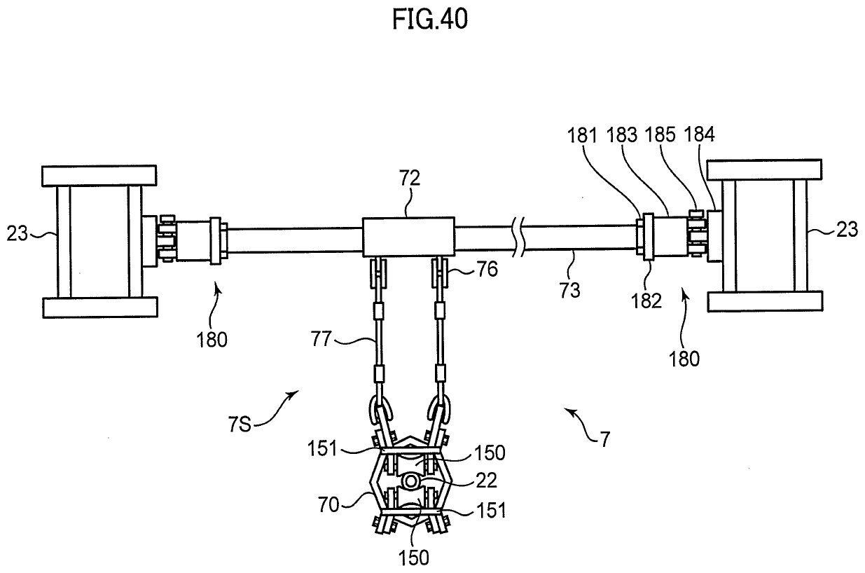

Next, a fifteenth embodiment of the present invention will be described. FIG. 40 is a front view of a rope inspection device 7 of a crane 1 according to the present embodiment. While an aspect in which the support rollers 150 are disposed on one side of the boom raising/lowering rope 22 when viewed in a cross section orthogonal to the boom raising/lowering rope 22 has been described in the thirteenth and fourteenth embodiments, the support rollers 150 may be disposed on both sides of the boom raising/lowering rope 22 as illustrated in FIG. 40. In this case, the pair of support rollers 150 is disposed so as to sandwich the boom raising/lowering rope 22 from both sides, and thus the relative positional relationship between the rope deterioration detector 70 and the boom raising/lowering rope 22 can be stably maintained even in various postures of the mast 23 with respect to the upper slewing body 12. Note that, also in the present embodiment, it is desirable that the support rollers 150 are disposed on both sides of the rope deterioration detector 70 in the direction in which the main winding rope 51 extends. In another embodiment, in FIG. 40, three or more support rollers 150 may be disposed so as to surround the boom raising/lowering rope 22.

The rope inspection device 7 according to each of the embodiments of the present invention and the crane 1 including the same have been described above. With the crane 1 including the rope inspection device 7 as described above, the rope deterioration detector 70 can move following each rope, so that it is possible to stably inspect the rope. Note that the present invention is not limited to these embodiments. In the present invention, modified embodiments as follows are possible.
(1) While an aspect in which the rope deterioration detector 70 of the rope inspection device 7 is swingably supported by the support link has been described in the above embodiment, the structure for supporting the rope deterioration detector 70 is not limited to a link structure. The rope deterioration detector 70 may be supported by a cable, a wire, or the like, or may be supported so as to be movable along other guide members or rail members.
(2) The configurations and features of the embodiments described above can be combined with one another.
(3) The embodiments described above have been described using the crane 1 illustrated in FIG. 1, but the present invention is not limited to this, and can be applied also to a crane having another structure. That is, the crane to which the present invention is applied may include a lattice mast (mast) instead of the gantry, and each winch may be disposed on the lattice mast or the boom. In addition, the boom may be raised and lowered by raising and lowering of a box mast (mast). Further, the crane 1 may have struts such as a front strut and a rear strut, and may have a jib at the tip end of the boom 16. The travelling structure of the lower travelling body 14 may be a crawler or a tire, or a fixed lower body may be provided in place of the lower travelling body 14. The work machine according to the present invention is not limited to a crane, and may be other aspects.

A rope inspection device according to a first aspect of the present invention is a rope inspection device attached to a work machine having a machine body, a rising/lowering body capable of rising/lowering relative to the machine body, a winch, and a rope that is led out from the winch, the rope inspection device including a rope inspection unit capable of inspecting a deterioration state of the rope, and a support unit attached to a predetermined attachment target portion of the work machine, the support unit supporting the rope inspection unit so that the rope inspection unit is able to follow movement of the rope.

In this configuration, the support unit supports the rope inspection unit so that the rope inspection unit capable of inspecting a deterioration state of the rope is able to follow movement of the rope. The support unit is attached on a predetermined attachment target portion of the work machine. With such a configuration, even when the position of the rope changes with operation of the work machine, the rope inspection unit can move following the rope, so that the rope can be stably inspected.

A rope inspection device according to a second aspect of the present invention is the rope inspection device according to the first aspect, in which the support unit has a support mechanism supported by the attachment target portion, and a support member that is suspended from the support mechanism and swingably supports the rope inspection unit.

With this configuration, since the support member swingably supports the rope inspection unit, the rope inspection unit can easily move following the rope even when the position of the rope changes.

A rope inspection device according to a third aspect of the present invention is the rope inspection device according to the second aspect, in which the rope is disposed to extend obliquely upward from the winch, and the support member tilts and supports the rope inspection unit along a direction in which the rope extends.

With this configuration, the posture of the rope inspection unit can be maintained along the direction in which the rope extends from the winch.

A rope inspection device according to a fourth aspect of the present invention is the rope inspection device according to the second or third aspect, in which the support member has an up-down movement allowing unit that allows the rope inspection unit to move up and down following the movement of the rope in an up-down direction.

With this configuration, even if the position of the rope changes up and down with the operation of the work machine, the rope inspection unit can move following the rope.

A rope inspection device according to a fifth aspect of the present invention is the rope inspection device according to any one of the second to fourth aspects, in which the support mechanism has an up-down position adjustment unit capable of adjusting a position of the rope inspection unit in an up-down direction with respect to the attachment target portion.

With this configuration, the position of the rope inspection unit in the up-down direction can be easily adjusted according to the position of the winch and the position of the rope led out from the winch.

A rope inspection device according to a sixth aspect of the present invention is the rope inspection device according to any one of the second to fifth aspects, in which the support mechanism has a support pin and a holder that is held by the support pin so as to be relatively movable with respect to the support pin along a direction in which the support pin extends, and supports the support member.

With this configuration, even if the position of the rope changes in the extending direction of the support pin with the operation of the work machine, the rope inspection unit can move following the rope.

A rope inspection device according to a seventh aspect of the present invention is the rope inspection device according to any one of the second to sixth aspects, in which the support mechanism has at least a pair of left and right attachment portions attached to the attachment target portion, and a width adjusting part capable of adjusting a width of at least the pair of left and right attachment portions in a left-right direction.

With this configuration, the width of the attachment portion can be adjusted according to the width dimension of the machine body in the left-right direction, and the rope inspection device can be easily attached to the machine body.

A rope inspection device according to an eighth aspect of the present invention is the rope inspection device according to any one of the second to fifth aspects, in which the attachment target portion has a pair of left and right inner surfaces disposed to face each other, and the support mechanism has a support pin that supports the support member, a pair of left and right attachment portions disposed at both ends of the support pin, and a pair of left and right width adjusting parts that bias the pair of left and right attachment portions toward the pair of left and right inner surfaces by adjusting an interval between the pair of left and right attachment portions in the left-right direction.

With this configuration, the pair of left and right width adjusting parts biases the attachment portions toward the inner surfaces, so that the rope inspection unit can be easily attached in accordance with the size of the attachment target portion.

A rope inspection device according to a ninth aspect of the present invention is the rope inspection device according to any one of the first to eighth aspects, in which the machine body of the work machine has a main body frame that supports the rising/lowering body so that the rising/lowering body is capable of rising/lowering, and a backstop that is interposed between the main body frame and the rising/lowering body and supports the rising/lowering body from behind, and the support unit is attached to the backstop as the attachment target portion.

With this configuration, the rope inspection unit can be stably supported using the backstop on the main body frame.

A rope inspection device according to a tenth aspect of the present invention is the rope inspection device according to any one of the first to eighth aspects, in which the machine body of the work machine has a main body frame that supports the rising/lowering body so that the rising/lowering body is capable of rising/lowering, and a rear support body erected on the main body frame behind the rising/lowering body, the rear support body including a gantry or a mast supporting the rising/lowering body from behind, and the support unit is attached to the rear support body as the attachment target portion.

With this configuration, the rope inspection unit can be stably supported using the rear support body on the main body frame.

A rope inspection device according to an eleventh aspect of the present invention is the rope inspection device according to any one of the first to eighth aspects, in which the machine body of the work machine has a main body frame that supports the rising/lowering body so that the rising/lowering body is capable of rising/lowering, a backstop that is interposed between the main body frame and the rising/lowering body and supports the rising/lowering body from behind, a rear support body erected on the main body frame behind the backstop, the rear support body including a gantry or a mast supporting the rising/lowering body from behind, and a bridging portion disposed above the main body frame so as to connect the backstop and the rear support body along a front-rear direction, and the support unit is attached to the bridging portion as the attachment target portion.

With this configuration, the rope inspection unit can be stably supported using the bridging portion disposed between the backstop on the main body frame and the rear support body.

A rope inspection device according to a twelfth aspect of the present invention is the rope inspection device according to the eleventh aspect, in which the bridging portion has an intermediate portion positioned between the backstop and the rear support body, and a protrusion connected to the intermediate portion and disposed to protrude from the backstop or the rear support body, and the support unit is attached to at least one of the intermediate portion or the protrusion.

With this configuration, it is possible to stably support the rope inspection unit by using the intermediate portion between the backstop and the rear support body and the protrusion protruding from the backstop or the rear support body.

A rope inspection device according to a thirteenth aspect of the present invention is the rope inspection device according to any one of the first to eighth aspects, in which the machine body of the work machine has a main body frame that supports the rising/lowering body so that the rising/lowering body is capable of rising/lowering, and a guard that is disposed on the main body frame and protects a predetermined device, and the support unit is attached to the guard as the attachment target portion.

With this configuration, the rope inspection unit can be stably supported using the guard disposed on the main body frame.

A rope inspection device according to a fourteenth aspect of the present invention is the rope inspection device according to any one of the first to eighth aspects, in which the winch includes a rotatable winch drum, the machine body of the work machine has a main body frame that supports the rising/lowering body so that the rising/lowering body is capable of rising/lowering, and a drum cover that is disposed on the main body frame and protects the winch drum, and the support unit is attached on the drum cover as the attachment target portion.

With this configuration, the rope inspection unit can be stably supported using the drum cover disposed on the main body frame.

A rope inspection device according to a fifteenth aspect of the present invention is the rope inspection device according to any one of the first to eighth aspects, in which the support unit is attached on the rising/lowering body as the attachment target portion.

With this configuration, the rope inspection unit can be stably supported using the rising/lowering body supported by the machine body.

A rope inspection device according to a sixteenth aspect of the present invention is the rope inspection device according to the fifteenth aspect, in which the support unit further includes a rising/lowering support member that prevents contact between the rope and the rope inspection unit by coming into contact with the rope at a predetermined rising/lowering angle of the rising/lowering body relative to the machine body.

With this configuration, the rising/lowering support member comes into contact with the rope at the predetermined rising/lowering angle of the rising/lowering body, whereby the rope inspection unit and the rope can be prevented from coming into contact with each other.

A rope inspection device according to a seventeenth aspect of the present invention is the rope inspection device according to the sixteenth aspect, in which the rising/lowering support member includes at least one roller including an outer peripheral surface capable of supporting the rope.

With this configuration, it is possible to prevent a large load from being applied to the rope and the rope inspection unit by the outer peripheral surface of the roller coming into contact with the rope.

A rope inspection device according to an eighteenth aspect of the present invention is the rope inspection device according to the seventeenth aspect, in which the at least one roller includes a pair of rollers disposed on both sides of the rope inspection unit in a direction in which the rope extends.

With this configuration, since the rollers come into contact with the rope on both sides of the rope inspection unit, it is possible to stably prevent contact between the rope and the rope inspection unit.

A rope inspection device according to a nineteenth aspect of the present invention is the rope inspection device according to any one of the fifteenth to eighteenth aspects, in which the rising/lowering body has at least a pair of extending members, and the support unit is attached to the pair of extending members.

With this configuration, the support unit can be stably supported using the pair of extending members of the rising/lowering body.

A rope inspection device according to a twentieth aspect of the present invention is the rope inspection device according to the nineteenth aspect, in which the pair of extending members is a pair of scaffolding members movable by an operator.

With this configuration, the support unit can be stably supported using the scaffolding members of the rising/lowering body.

A rope inspection device according to a twenty-first aspect of the present invention is the rope inspection device according to the nineteenth aspect, in which the pair of extending members is a pair of lattice members extending in directions different from each other.

With this configuration, the support unit can be stably supported by using the pair of lattice members of the rising/lowering body.

A rope inspection device according to a twenty-second aspect of the present invention is the rope inspection device according to the twenty-first aspect, in which the rising/lowering body further has a bridging portion disposed to connect the pair of lattice members, and the support unit is attached to the bridging portion.

With this configuration, even when the directions of the pair of lattice members are different, the support unit can be stably supported by the bridging portion.

A work machine according to another aspect of the present invention includes a machine body, a rising/lowering body capable of rising/lowering relative to the machine body, a winch, a rope that is led out from the winch, and the rope inspection device according to any one of the first to twenty-second aspects.

With this configuration, even when the position of the rope changes with the operation of the work machine, the rope inspection unit can move following the rope, so that the rope can be stably inspected.

1. A rope inspection device attached to a work machine having a machine body, a rising/lowering body capable of rising/lowering relative to the machine body, a winch, and a rope that is led out from the winch, the rope inspection device comprising:
a rope inspection unit capable of inspecting a deterioration state of the rope; and
a support unit attached to a predetermined attachment target portion of the work machine, the support unit supporting the rope inspection unit so that the rope inspection unit is able to follow movement of the rope.

2. The rope inspection device according to claim 1, wherein
the support unit has
a support mechanism supported by the attachment target portion, and
a support member that is suspended from the support mechanism and swingably supports the rope inspection unit.

3. The rope inspection device according to claim 2, wherein
the rope is disposed to extend obliquely upward from the winch, and
the support member tilts and supports the rope inspection unit along a direction in which the rope extends.

4. The rope inspection device according to claim 2, wherein the support member has an up-down movement allowing unit that allows the rope inspection unit to move up and down following the movement of the rope in an up-down direction.

5. The rope inspection device according to claim 2, wherein the support mechanism has an up-down position adjustment unit capable of adjusting a position of the rope inspection unit in an up-down direction with respect to the attachment target portion.

6. The rope inspection device according to claim 2, wherein
the support mechanism has
a support pin, and
a holder that is held by the support pin so as to be relatively movable with respect to the support pin along a direction in which the support pin extends, and supports the support member.

7. The rope inspection device according to claim 2, wherein
the support mechanism has
at least a pair of left and right attachment portions attached to the attachment target portion, and
a width adjusting part capable of adjusting a width of at least the pair of left and right attachment portions in a left-right direction.

8. The rope inspection device according to claim 2, wherein
the attachment target portion has a pair of left and right inner surfaces disposed to face each other, and
the support mechanism has
a support pin that supports the support member,
a pair of left and right attachment portions disposed at both ends of the support pin, and
a pair of left and right width adjusting parts that bias the pair of left and right attachment portions toward the pair of left and right inner surfaces by adjusting an interval between the pair of left and right attachment portions in the left-right direction.

9. The rope inspection device according to claim 1, wherein
the machine body of the work machine has
a main body frame that supports the rising/lowering body so that the rising/lowering body is capable of rising/lowering, and
a backstop that is interposed between the main body frame and the rising/lowering body and supports the rising/lowering body from behind, and the support unit is attached to the backstop as the attachment target portion.

10. The rope inspection device according to claim 1, wherein
the machine body of the work machine has
a main body frame that supports the rising/lowering body so that the rising/lowering body is capable of rising/lowering, and
a rear support body erected on the main body frame behind the rising/lowering body, the rear support body including a gantry or a mast supporting the rising/lowering body from behind, and
the support unit is attached to the rear support body as the attachment target portion.

11. The rope inspection device according to claim 1, wherein
the machine body of the work machine has
a main body frame that supports the rising/lowering body so that the rising/lowering body is capable of rising/lowering,
a backstop that is interposed between the main body frame and the rising/lowering body and supports the rising/lowering body from behind,
a rear support body erected on the main body frame behind the backstop, the
rear support body including a gantry or a mast supporting the rising/lowering body from behind, and
a bridging portion disposed above the main body frame so as to connect the backstop and the rear support body along a front-rear direction, and
the support unit is attached to the bridging portion as the attachment target portion.

12. (canceled)

13. The rope inspection device according to claim 1, wherein
the machine body of the work machine has
a main body frame that supports the rising/lowering body so that the rising/lowering body is capable of rising/lowering, and
a guard that is disposed on the main body frame and protects a predetermined device, and
the support unit is attached to the guard as the attachment target portion.

14. The rope inspection device according to claim 1, wherein
the winch includes a rotatable winch drum,
the machine body of the work machine has
a main body frame that supports the rising/lowering body so that the rising/lowering body is capable of rising/lowering, and
a drum cover that is disposed on the main body frame and protects the winch drum, and
the support unit is attached on the drum cover as the attachment target portion.

15. The rope inspection device according to claim 1, wherein the support unit is attached on the rising/lowering body as the attachment target portion,
wherein the support unit further includes a rising/lowering support member that prevents contact between the rope and the rope inspection unit by coming into contact with the rope at a predetermined rising/lowering angle of the rising/lowering body relative to the machine body.

16. (canceled)

17. The rope inspection device according to claim 15, wherein the rising/lowering support member includes at least one roller including an outer peripheral surface capable of supporting the rope.

18. The rope inspection device according to claim 17, wherein the at least one roller includes a pair of rollers disposed on both sides of the rope inspection unit in a direction in which the rope extends.

19. The rope inspection device according to claim 15, wherein
the rising/lowering body has at least a pair of extending members, and
the support unit is attached to the pair of extending members.

20-22. (canceled)

23. A work machine comprising:
a machine body;
a rising/lowering body capable of rising/lowering relative to the machine body;
a winch;
a rope that is led out from the winch; and
the rope inspection device according to claim 1.
